(19) United States
(12) Patent Application Publication
(10) Pub. No.: US 2018/0359117 A1
(43) Pub. Date: Dec. 13, 2018

(54) VIRTUAL CHANNEL INSTANTIATION OVER VGI/VGMI

(71) Applicant: QUALCOMM Incorporated, San Diego, CA (US)

(72) Inventors: Richard Dominic WIETFELDT, San Diego, CA (US); Lalan Jee MISHRA, San Diego, CA (US)

(21) Appl. No.: 15/992,046

(22) Filed: May 29, 2018

Related U.S. Application Data
(60) Provisional application No. 62/518,530, filed on Jun. 12, 2017.

(51) Int. Cl. H04L 12/54; H04L 12/935; H04L 5/00; H04L 29/06

(52) U.S. Cl. CPC H04L 12/5601; H04L 49/3081; H04L 2012/563; H04L 63/0428; H04L 5/0044

(57) ABSTRACT

In an aspect, an apparatus obtains a payload to be transmitted to a receiver device, obtains a virtual general-purpose input/output and messaging interface (VGMI) packet that includes at least the payload, a virtual channel identifier, and a function bit configured as a virtual channel marker bit to indicate that the VGMI packet includes the virtual channel identifier, wherein the virtual channel identifier indicates information associated with processing the payload, and transmits the VGMI packet to the receiver device. In another aspect, an apparatus receives a VGMI packet from a transmitter device, wherein the VGMI packet includes at least a payload and a virtual channel identifier, determines that the VGMI packet includes the virtual channel identifier based on a function bit configured as a virtual channel marker bit, wherein the virtual channel identifier indicates information associated with processing the payload, and processes the data based on the information.

### CLAIM OF PRIORITY UNDER 35 U.S.C. § 119

The present Application for Patent claims priority to U.S. Provisional Application No. 62/518,530 entitled “VIRTUAL CHANNEL INSTANTIATION OVER VGI/VGMI” filed Jun. 12, 2017, which is assigned to the assignee hereof and hereby expressly incorporated by reference herein.

### INTRODUCTION

### Field of the Disclosure

Aspects of the disclosure relate generally to techniques for virtual channel instantiation over VGI/VGMI.

### BACKGROUND

Virtual channels may be implemented in communications between two devices to define the characteristics of a data payload for efficient processing. In the current point-to-point (P2P) virtual general-purpose input/output interface (VMI) (also referred to as virtual general-purpose input/output and messaging interface (VGMI)) specification, messaging is supported. However, certain message transmissions may require additional complimentary transmission(s), adding to overall increase in transmission and/or processing latency.

For example, a data packet transmission from a first device to a second device may contain an encrypted message (e.g., a payload of the data packet may include encrypted data). The first device, however, must notify the second device about the characteristics of the data packet (e.g., that the data packet includes an encrypted message) to enable the second device to successfully process the data packet. For example, the first device may transmit a pilot message (also referred to as a pilot packet) to the second device prior to the transmission of the data packet to indicate that an encrypted message is to follow. Such pilot message adds latency to the communication process.

In addition, the VGMI specification allows messaging channel consolidation. For example, a VGMI block may need to aggregate legacy serial interface channels such as I2C, serial peripheral interface (SPI), etc. The current approach for interface channel consolidation requires a register mapping scheme, such that the transmitter/receiver pair may determine the type of interface-channel based on a register address-space. This approach, however, needs a predefined register space allocation and brings many design level challenges.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In an aspect of the disclosure, a method for an apparatus is disclosed. The apparatus obtains a payload to be transmitted to a receiver device, and obtains a virtual general-purpose input/output and messaging interface packet that includes at least the payload, a virtual channel identifier, and a function bit configured as a virtual channel marker bit to indicate that the virtual general-purpose input/output and messaging interface packet includes the virtual channel identifier, wherein the virtual channel identifier indicates information associated with processing the payload. The apparatus transmits the virtual general-purpose input/output and messaging interface packet to the receiver device.

In an aspect of the disclosure, the apparatus sets a virtual channel configuration register to indicate that the function bit is configured as the virtual channel marker bit, and enables the function bit in the virtual general-purpose input/output and messaging interface packet. In an aspect of the disclosure, the virtual channel identifier includes a virtual channel source device identifier that identifies the transmitter device, and a virtual channel function code that indicates the information associated with processing the payload.

In an aspect of the disclosure, the virtual channel function code includes at least a control channel marker bit, an encryption marker bit, a priority marker bit, or an acknowledge request marker bit. In an aspect, the virtual channel identifier is included in a byte following the enabled function bit in the virtual general-purpose input/output and messaging interface packet. In an aspect of the disclosure, the virtual general-purpose input/output and messaging interface packet is transmitted to the receiver device over an I2C or I3C bus.

In an aspect of the disclosure, the payload included in the virtual general-purpose input/output and messaging interface packet is encrypted, and an encryption marker bit in the virtual channel identifier is enabled to indicate that the payload is encrypted.

In an aspect of the disclosure, an apparatus is disclosed. The apparatus includes a communication interface configured to communicate with one or more peripheral devices, and a processing circuit coupled to the communication interface. The processing circuit is configured to obtain a payload to be transmitted to a receiver device and a virtual general-purpose input/output and messaging interface packet that includes at least the payload, a virtual channel identifier, and a function bit configured as a virtual channel marker bit to indicate that the virtual general-purpose input/output and messaging interface packet includes the virtual channel identifier, wherein the virtual channel identifier indicates information associated with processing the payload. The processing circuit is further configured to transmit the virtual general-purpose input/output and messaging interface packet to the receiver device.

In an aspect of the disclosure, an apparatus is disclosed. The apparatus includes means for obtaining a payload to be transmitted to a receiver device, means for obtaining a virtual general-purpose input/output and messaging interface packet that includes at least the payload, a virtual channel identifier, and a function bit configured as a virtual channel marker bit to indicate that the virtual general-purpose input/output and messaging interface packet includes the virtual channel identifier, wherein the virtual channel identifier indicates information associated with processing the payload, and means for transmitting the virtual general-purpose input/output and messaging interface packet to the receiver device.

In an aspect of the disclosure, a processor-readable storage medium is disclosed. The processor-readable storage medium includes one or more instructions which, when executed by at least one processor or state machine of a processing circuit, cause the processing circuit to obtain a payload to be transmitted to a receiver device, obtain a virtual general-purpose input/output and messaging interface packet that includes at least the payload, a virtual channel identifier, and a function bit configured as a virtual channel marker bit to indicate that the virtual general-purpose input/output and messaging interface packet includes the virtual channel identifier, wherein the virtual channel identifier indicates information associated with processing the payload, and transmit the virtual general-purpose input/output and messaging interface packet to the receiver device.

In an aspect of the disclosure, a method for a receiver device is disclosed. The receiver device receives a virtual general-purpose input/output and messaging interface packet from a transmitter device, wherein the virtual general-purpose input/output and messaging interface packet includes at least a payload and a virtual channel identifier, determines that the virtual general-purpose input/output and messaging interface packet includes the virtual channel identifier based on a function bit configured as a virtual channel marker bit, wherein the virtual channel identifier indicates information associated with processing the payload, and processes the payload based on the information.

In an aspect of the disclosure, the determination that the virtual general-purpose input/output and messaging interface packet includes a virtual channel identifier includes determining that a virtual channel configuration register indicates that the function bit in the virtual general-purpose input/output and messaging interface packet is configured as the virtual channel marker bit, and determining that the function bit in the virtual general-purpose input/output and messaging interface packet is enabled.

In an aspect of the disclosure, the virtual channel identifier includes a virtual channel source device identifier that identifies the transmitter device, and a virtual channel function code that indicates the information associated with processing the payload. In an aspect, the virtual channel function code includes at least a control channel marker bit, an encryption marker bit, a priority marker bit, or an acknowledge request marker bit. In an aspect, the virtual channel identifier is included in a byte following the enabled function bit in the virtual general-purpose input/output and messaging interface packet. In an aspect, the virtual general-purpose input/output and messaging interface packet is received over an I2C or I3C bus.

In an aspect of the disclosure, the receiver device determines that an encryption marker bit in the virtual channel identifier is enabled, the enabled encryption marker bit indicating that the payload is encrypted. In this aspect, processing the payload by the receiver device includes decrypting the payload.

In an aspect of the disclosure, an apparatus is disclosed. The apparatus includes a communication interface configured to communicate with one or more peripheral devices, and a processing circuit coupled to the communication interface. The processing circuit is configured to receive a virtual general-purpose input/output and messaging interface packet from a transmitter device, wherein the virtual general-purpose input/output and messaging interface packet includes at least a payload and a virtual channel identifier, determine that the virtual general-purpose input/output and messaging interface packet includes the virtual channel identifier based on a function bit configured as a virtual channel marker bit, wherein the virtual channel identifier indicates information associated with processing the payload, and process the payload based on the information.

In an aspect of the disclosure, an apparatus is disclosed. The apparatus includes means for receiving a virtual general-purpose input/output and messaging interface packet from a transmitter device, wherein the virtual general-purpose input/output and messaging interface packet includes at least a payload and a virtual channel identifier, means for determining that the virtual general-purpose input/output and messaging interface packet includes the virtual channel identifier based on a function bit configured as a virtual channel marker bit, wherein the virtual channel identifier indicates information associated with processing the payload, and means for processing the payload based on the information.

In an aspect of the disclosure, a processor-readable storage medium is disclosed. The processor-readable storage medium includes one or more instructions which, when executed by at least one processor or state machine of a processing circuit, cause the processing circuit to receive a virtual general-purpose input/output and messaging interface packet from a transmitter device, wherein the virtual general-purpose input/output and messaging interface packet includes at least a payload and a virtual channel identifier, determine that the virtual general-purpose input/output and messaging interface packet includes the virtual channel identifier based on a function bit configured as a virtual channel marker bit, wherein the virtual channel identifier indicates information associated with processing the payload, and process the payload based on the information.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device that employs an RFFE bus to couple various radio frequency front-end devices.

FIG. 4 illustrates a device that employs an I3C bus to couple various front-end devices in accordance with certain aspects disclosed herein.

FIG. 5 illustrates an apparatus that includes an Application Processor and multiple peripheral devices that may be adapted according to certain aspects disclosed herein.

FIG. 6 illustrates an apparatus that has been adapted to support Virtual GPIO in accordance with certain aspects disclosed herein.

FIG. 7 illustrates examples of VGI broadcast frames according to certain aspects disclosed herein.

FIG. 8 illustrates examples of VGI directed frames according to certain aspects disclosed herein.

FIG. 9 illustrates configuration registers that may be associated with a physical pin according to certain aspects disclosed herein.

FIG. 10 illustrates a device including a host system-on-chip (SoC) device in communication with a number of peripheral devices.

FIG. 11 shows an example VGMI packet for communication of VGPIO signals or message signals.

FIG. 12 shows an example VGMI packet for communication of VGPIO signals or message signals.

FIG. 13 shows an example VGMI packet for communication of VGPIO signals or message signals.

FIG. 14 shows an example configuration of a virtual channel identifier in accordance with various aspects of the disclosure.

FIG. 15 shows an example implementation of a virtual channel configuration register in accordance with various aspects of the disclosure.

FIG. 16 shows an example of a VGMI packet implementing virtual channel instantiation in accordance with various aspects of the disclosure.

FIG. 17 is block diagram illustrating select components of an apparatus according to at least one example of the disclosure.

FIG. 18 is a flowchart illustrating a method for an apparatus.

FIG. 19 is block diagram illustrating select components of an apparatus according to at least one example of the disclosure.

FIG. 20 is a flowchart illustrating a method for an apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

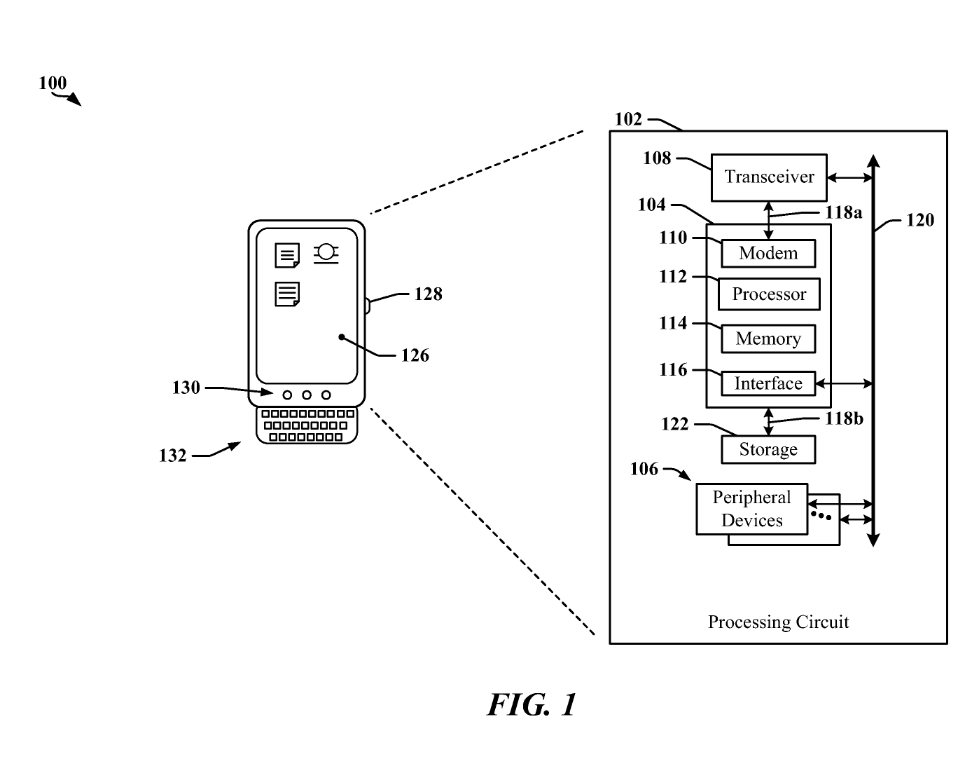

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

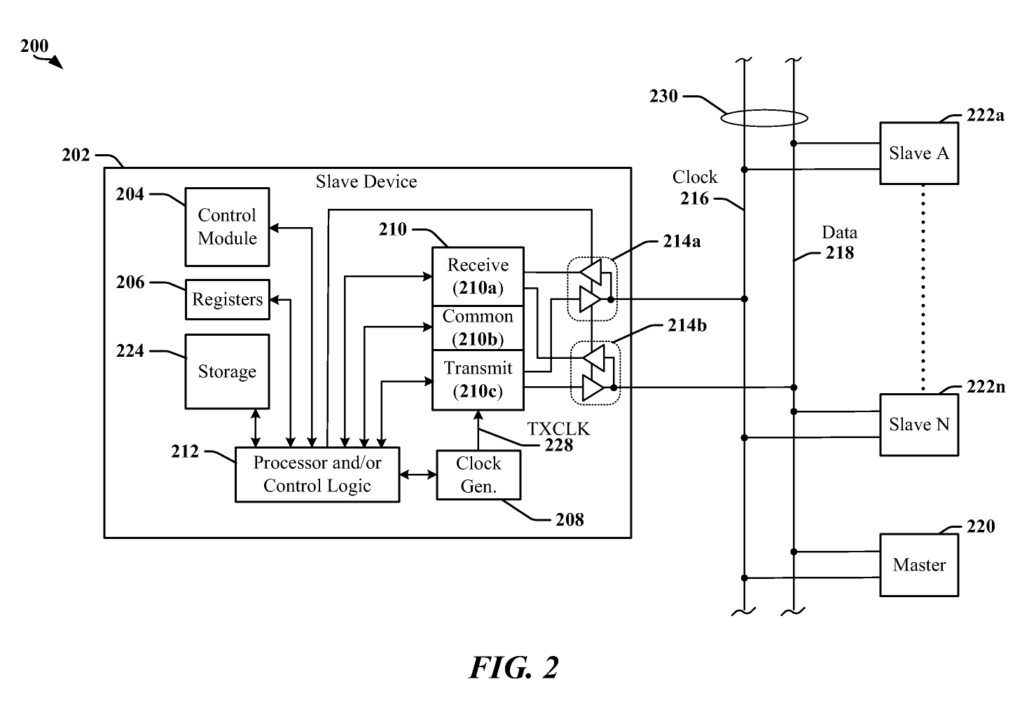

FIG. 2 illustrates certain aspects of an apparatus 200 that includes multiple devices 202, 220 and 222a-222n connected to a serial bus 230. The devices 202, 220 and 222a-222n may include one or more semiconductor IC devices, such as an applications processor, SoC or ASIC. Each of the devices 202, 220 and 222a-222n may include, support or operate as a modem, a signal processing device, a display driver, a camera, a user interface, a sensor, a sensor controller, a media player, a transceiver, and/or other such components or devices. Communications between devices 202, 220 and 222a-222n over the serial bus 230 is controlled by a bus master 220. Certain types of bus can support multiple bus masters 220.

The apparatus 200 may include multiple devices 202, 220 and 222a-222n that communicate when the serial bus 230 is operated in accordance with I2C, I3C or other protocols. At least one device 202, 222a-222n may be configured to operate as a slave device on the serial bus 230. In one example, a slave device 202 may be adapted to provide a control function 204. In some examples, the control function 204 may include circuits and modules that support a display, an image sensor, and/or circuits and modules that control and communicate with one or more sensors that measure environmental conditions. The slave device 202 may include configuration registers 206 or other storage 224, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits and/or devices. In one example, the transmitter 210c encodes and transmits data based on timing in one or more signals 228 provided by a clock generation circuit 208.

Two or more of the devices 202, 220 and/or 222a-222n may be adapted according to certain aspects and features disclosed herein to support a plurality of different communication protocols over a common bus, which may include an I2C and/or I3C protocol. In some instances, devices that communicate using the I2C protocol can coexist on the same 2-wire interface with devices that communicate using I3C protocols. In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 230, in addition to data formats and aspects of bus control. In some aspects, the I2C and I3C protocols may define direct current (DC) characteristics affecting certain signal levels associated with the serial bus 230, and/or alternating current (AC) characteristics affecting certain timing aspects of signals transmitted on the serial bus 230. In some examples, a 2-wire serial bus 230 transmits data on a first wire 218 and a clock signal on a second wire 216. In some instances, data may be encoded in the signaling state, or transitions in signaling state of the first wire 218 and the second wire 216.

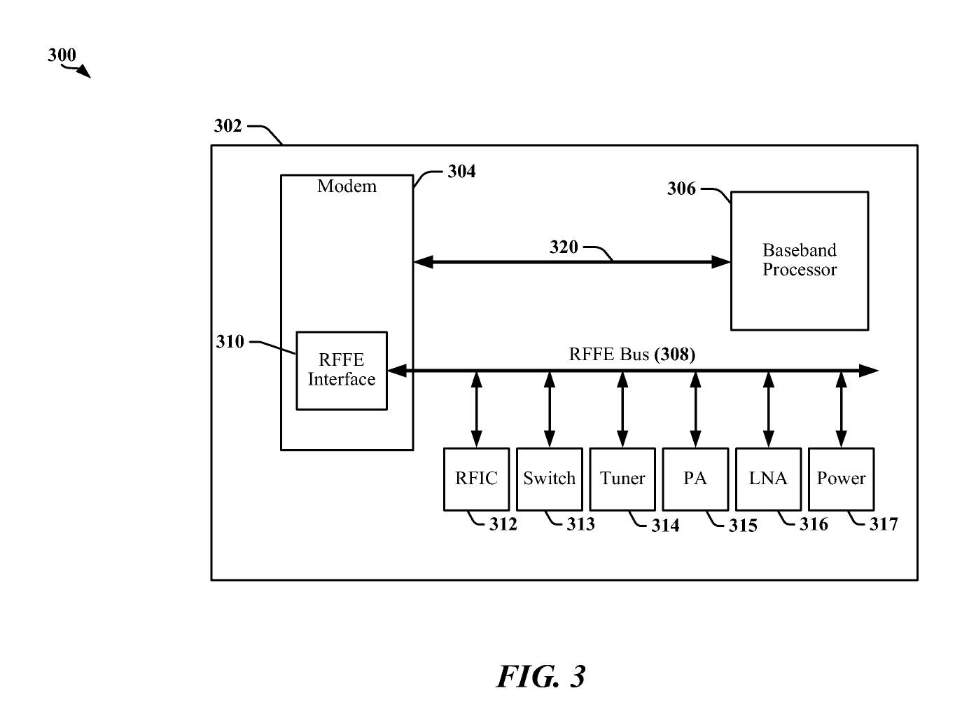

FIG. 3 is a block diagram 300 illustrating an example of a device 302 that employs an RFFE bus 308 to couple various front-end devices 312-317. A modem 304 may include an RFFE interface 310 that couples the modem 304 to the RFFE bus 308. The modem 304 may communicate with a baseband processor 306. The illustrated device 302 may be embodied in one or more of a mobile communication device, a mobile telephone, a mobile computing system, a mobile telephone, a notebook computer, a tablet computing device, a media player, a gaming device, a wearable computing and/or communications device, an appliance, or the like. In various examples, the device 302 may be implemented with one or more baseband processors 306, modems 304, multiple communications links 308, 320, and various other busses, devices and/or different functionalities. In the example illustrated in FIG. 3, the RFFE bus 308 may be coupled to an RF integrated circuit (RFIC) 312, which may include one or more controllers, and/or processors that configure and control certain aspects of the RF front-end. The RFFE bus 308 may couple the RFIC 312 to a switch 313, an RF tuner 314, a power amplifier (PA) 315, a low noise amplifier (LNA) 316 and a power management module 317.

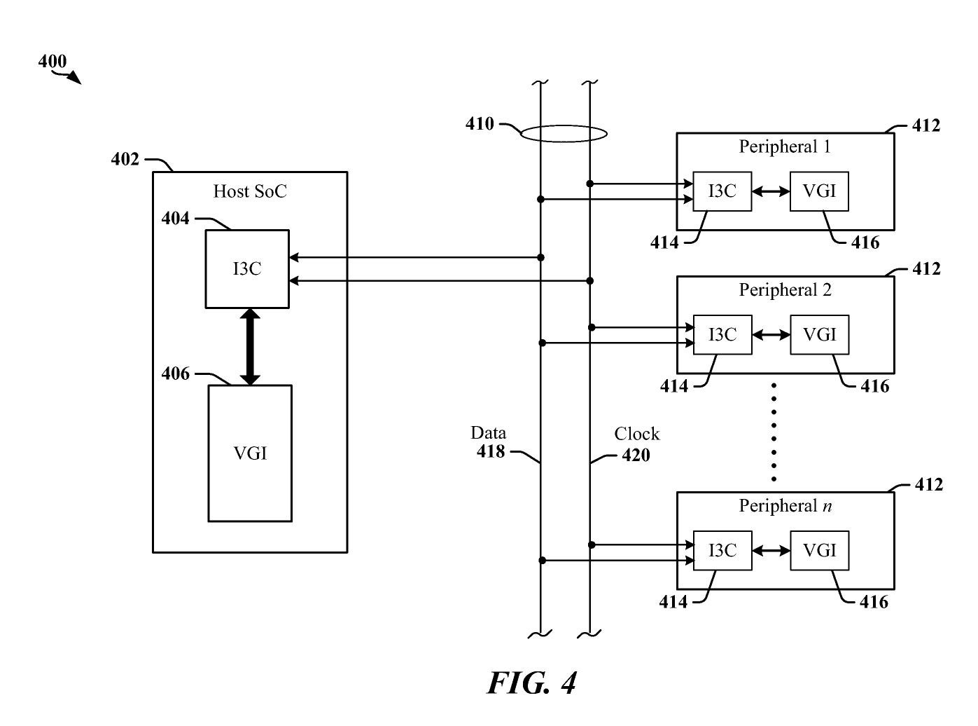

FIG. 4 illustrates an example of an apparatus 400 that uses an I3C bus to couple various devices including a host SoC 402 and a number of peripheral devices 412. The host SoC 402 may include a virtual GPIO finite state machine (VGI FSM 406) and an I3C interface 404, where the I3C interface 404 cooperates with corresponding I3C interfaces 414 in the peripheral devices 412 to provide a communication link between the host SoC 402 and the peripheral devices 412. Each peripheral device 412 includes a VGI FSM 416. In the illustrated example, communications between the SoC 402 and a peripheral device 412 may be serialized and transmitted over a multi-wire serial bus 410 in accordance with an I3C protocol. In other examples, the host SoC 402 may include other types of interface, including I2C and/or RFFE interfaces. In other examples, the host SoC 402 may include a configurable interface that may be employed to communicate using I2C, I3C, RFFE and/or another suitable protocol. In some examples, a multi-wire serial bus 410, such as an I2C or I3C bus, may transmit a data signal over a data wire 418 and a clock signal over a clock wire 420.

### Signaling Virtual GPIO Configuration Information

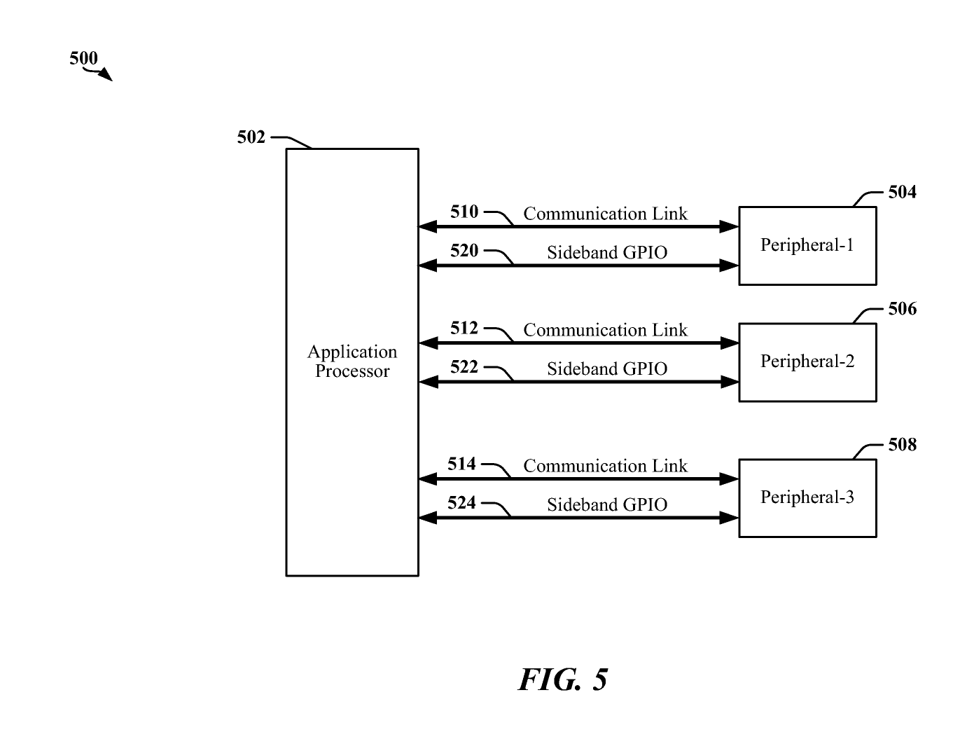

Mobile communication devices, and other devices that are related or connected to mobile communication devices, increasingly provide greater capabilities, performance and functionalities. In many instances, a mobile communication device incorporates multiple IC devices that are connected using a variety of communications links. FIG. 5 illustrates an apparatus 500 that includes an Application Processor 502 and multiple peripheral devices 504, 506, 508. In the example, each peripheral device 504, 506, 508 communicates with the Application Processor 502 over a respective communication link 510, 512, 514 operated in accordance with mutually different protocols. Communication between the Application Processor 502 and each peripheral device 504, 506, 508 may involve additional wires that carry control or command signals between the Application Processor 502 and the peripheral devices 504, 506, 508. These additional wires may be referred to as sideband general purpose input/output (sideband GPIO 520, 522, 524), and in some instances the number of connections needed for sideband GPIO 520, 522, 524 can exceed the number of connections used for a communication link 510, 512, 514.

GPIO provides generic pins/connections that may be customized for particular applications. For example, a GPIO pin may be programmable to function as an output, input pin or a bidirectional pin, in accordance with application needs. In one example, the Application Processor 502 may assign and/or configure a number of GPIO pins to conduct handshake signaling or inter-processor communication (IPC) with a peripheral device 504, 506, 508 such as a modem. When handshake signaling is used, sideband signaling may be symmetric, where signaling is transmitted and received by the Application Processor 502 and a peripheral device 504, 506, 508. With increased device complexity, the increased number of GPIO pins used for IPC communication may significantly increase manufacturing cost and limit GPIO availability for other system-level peripheral interfaces.

According to certain aspects, the state of GPIO, including GPIO associated with a communication link, may be captured, serialized and transmitted over a data communication link. In one example, captured GPIO may be transmitted in packets over an I3C bus using common command codes to indicate packet content and/or destination.

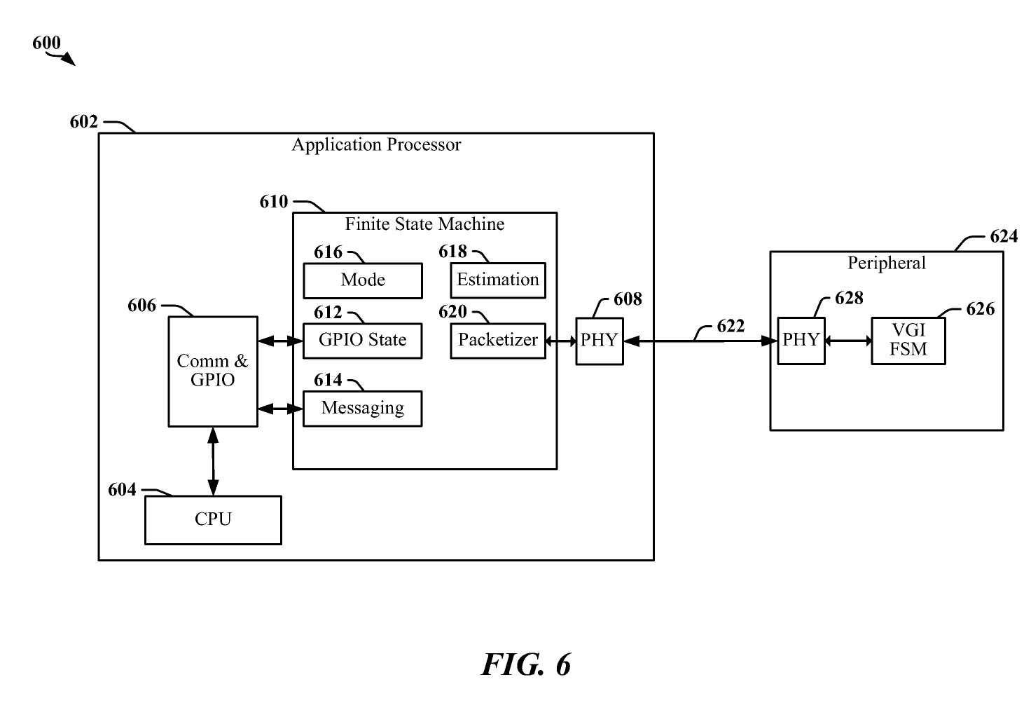

FIG. 6 illustrates an apparatus 600 that is adapted to support Virtual GPIO (VGI or VGMI) in accordance with certain aspects disclosed herein. VGI circuits and techniques can reduce the number of physical pins and connections used to connect an Application Processor 602 with a peripheral device 624. VGI enables a plurality of GPIO signals to be serialized into virtual GPIO signals that can be transmitted over a communication link 622. In one example, virtual GPIO signals may be encoded in packets that are transmitted over a communication link 622 that includes a multi-wire bus, including a serial bus. When the communication link 622 is provided as serial bus, the receiving peripheral device 624 may deserialize received packets and may extract messages and virtual GPIO signals. A VGI FSM 626 in the peripheral device 624 may convert the virtual GPIO signals to physical GPIO signals that can be presented at an internal GPIO interface.

In another example, the communication link 622 may be a provided by a radio frequency transceiver that supports wireless communication using, for example, a Bluetooth protocol, a wireless local area network (WLAN) protocol, a cellular wide area network, and/or another wireless communication protocol. When the communication link 622 includes a wireless connection, messages and virtual GPIO signals may be encoded in packets, frames, subframes, or other structures that can be transmitted over the communication link 622, and the receiving peripheral device 624 may extract, deserialize and otherwise process received signaling to obtain the messages and virtual GPIO signals. Upon receipt of messages and/or virtual GPIO signals, the VGI FSM 626 or another component of the receiving device may interrupt its host processor to indicate receipt of messages and/or any changes in in GPIO signals.

In an example in which the communication link 622 is provided as a serial bus, messages and/or virtual GPIO signals may be transmitted in packets configured for an I2C, I3C, RFFE or another standardized serial interface. In the illustrated example, VGI techniques are employed to accommodate I/O bridging between an Application Processor 602 and a peripheral device 624. The Application Processor 602 may be implemented as an ASIC, SoC or some combination of devices. The Application Processor 602 includes a processor (central processing unit or CPU 604) that generates messages and GPIO associated with one or more communications channels 606. GPIO signals and messages produced by the communications channels 606 may be monitored by respective monitoring circuits 612, 614 in a VGI FSM 626. In some examples, a GPIO monitoring circuit 612 may be adapted to produce virtual GPIO signals representative of the state of physical GPIO signals and/or changes in the state of the physical GPIO signals. In some examples, other circuits are provided to produce the virtual GPIO signals representative of the state of physical GPIO signals and/or changes in the state of the physical GPIO signals.

An estimation circuit 618 may be configured to estimate latency information for the GPIO signals and messages, and may select a protocol, and/or a mode of communication for the communication link 622 that optimizes the latency for encoding and transmitting the GPIO signals and messages. The estimation circuit 618 may maintain protocol and mode information 616 that characterizes certain aspects of the communication link 622 to be considered when selecting the protocol, and/or a mode of communication. The estimation circuit 618 may be further configured to select a packet type for encoding and transmitting the GPIO signals and messages. The estimation circuit 618 may provide configuration information used by a packetizer 620 to encode the GPIO signals and messages. In one example, the configuration information is provided as a command that may be encapsulated in a packet such that the type of packet can be determined at a receiver. The configuration information, which may be a command, may also be provided to physical layer circuits (PHY 608). The PHY 608 may use the configuration information to select a protocol and/or mode of communication for transmitting the associated packet. The PHY 608 may then generate the appropriate signaling to transmit the packet.

The peripheral device 624 may include a VGI FSM 626 that may be configured to process data packets received from the communication link 622. The VGI FSM 626 at the peripheral device 624 may extract messages and may map bit positions in virtual GPIO signals onto physical GPIO pins in the peripheral device 624. In certain embodiments, the communication link 622 is bidirectional, and both the Application Processor 602 and a peripheral device 624 may operate as both transmitter and receiver.

The PHY 608 in the Application Processor 602 and a corresponding PHY 628 in the peripheral device 624 may be configured to establish and operate the communication link 622. The PHY 608 and 628 may be coupled to, or include a wireless transceiver 108 (see FIG. 1) that supports wireless communications. In some examples, the PHY 608 and 628 may support a two-wire interface such an I2C, I3C, RFFE or SMBus interface at the Application Processor 602 and peripheral device 624, respectively and virtual GPIO and messages may be encapsulated into a packet transmitted over the communication link 622, which may be a multi-wire serial bus or multi-wire parallel bus for example.

VGI tunneling, as described herein, can be implemented using existing or available protocols configured for operating the communication link 622, and without the full complement of physical GPIO pins. VGI FSMs 610, 626 may handle GPIO signaling without intervention of a processor in the Application Processor 602 and/or in the peripheral device 624. The use of VGI can reduce pin count, power consumption, and latency associated with the communication link 622.

At the receiving device virtual GPIO signals are converted into physical GPIO signals. Certain characteristics of the physical GPIO pins may be configured using the virtual GPIO signals. For example, slew rate, polarity, drive strength, and other related parameters and attributes of the physical GPIO pins may be configured using the virtual GPIO signals. Configuration parameters used to configure the physical GPIO pins may be stored in configuration registers associated with corresponding GPIO pins. These configuration parameters can be addressed using a proprietary or conventional protocol such as I2C, I3C or RFFE. In one example, configuration parameters may be maintained in I3C addressable registers. Certain aspects disclosed herein relate to reducing latencies associated with the transmission of configuration parameters and corresponding addresses (e.g., addresses of registers used to store configuration parameters).

The VGI interface enables transmission of messages and virtual GPIOs, whereby virtual GPIOs, messages, or both can be sent in the serial data stream over a wired or wireless communication link 622. In one example, a serial data stream may be transmitted in packets and/or as a sequence of transactions over an I2C, I3C or RFFE bus. The presence of virtual GPIO data in I2C/I3C frame may be signaled using a special command code to identify the frame as a VGPIO frame. VGPIO frames may be transmitted as broadcast frames or addressed frames in accordance with an I2C or I3C protocol. In some implementations, a serial data stream may be transmitted in a form that resembles a universal asynchronous receiver/transmitter (UART) signaling protocol, in what may be referred to as VGI_UART mode of operation.

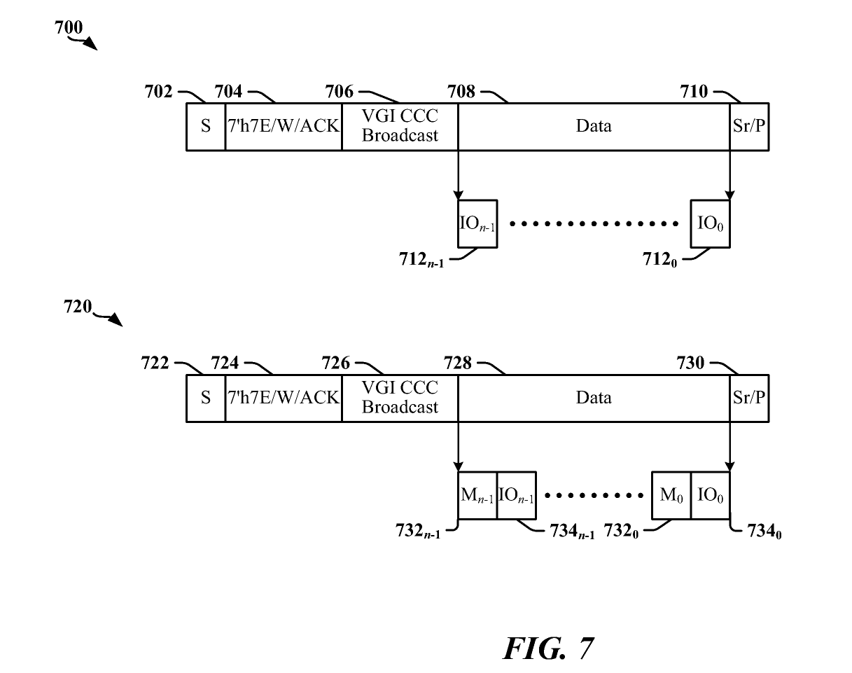

FIG. 7 illustrates examples of VGI broadcast frames 700, 720. In a first example, a broadcast frame 700 commences with a start bit 702 (S) followed by a header 704 in accordance with an I2C or I3C protocol. A VGI broadcast frame may be identified using a VGI broadcast common command code 706. A VGPIO data payload 708 includes a number (n) of virtual GPIO signals 712₀-712ₙ₋₁, ranging from a first virtual GPIO signal 712₀ to an nth virtual GPIO signal 712ₙ₋₁. A VGI FSM may include a mapping table that maps bit positions of virtual GPIO signals in a VGPIO data payload 708 to conventional GPIO pins. The virtual nature of the signaling in the VGPIO data payload 708 can be transparent to processors in the transmitting and receiving devices.

In the second example, a masked VGI broadcast frame 720 may be transmitted by a host device to change the state of one or more GPIO pins without disturbing the state of other GPIO pins. In this example, the I/O signals for one or more devices are masked, while the I/O signals in a targeted device are unmasked. The masked VGI broadcast frame 720 commences with a start bit 722 followed by a header 724. A masked VGI broadcast frame 720 may be identified using a masked VGI broadcast common command code 726. The VGPIO data payload 728 may include I/O signal values 734₀-734ₙ₋₁ and corresponding mask bits 732₀-732ₙ₋₁, ranging from a first mask bit M₀ 732₀ for the first I/O signal (IO₀) to an nth mask bit M_{n-1 7}32ₙ₋₁ for the nth I/O signal IOₙ₋₁.

A stop bit or synchronization bit (Sr/P 710, 730) terminates the broadcast frame 700, 720. A synchronization bit may be transmitted to indicate that an additional VGPIO payload is to be transmitted. In one example, the synchronization bit may be a repeated start bit in an I2C interface.

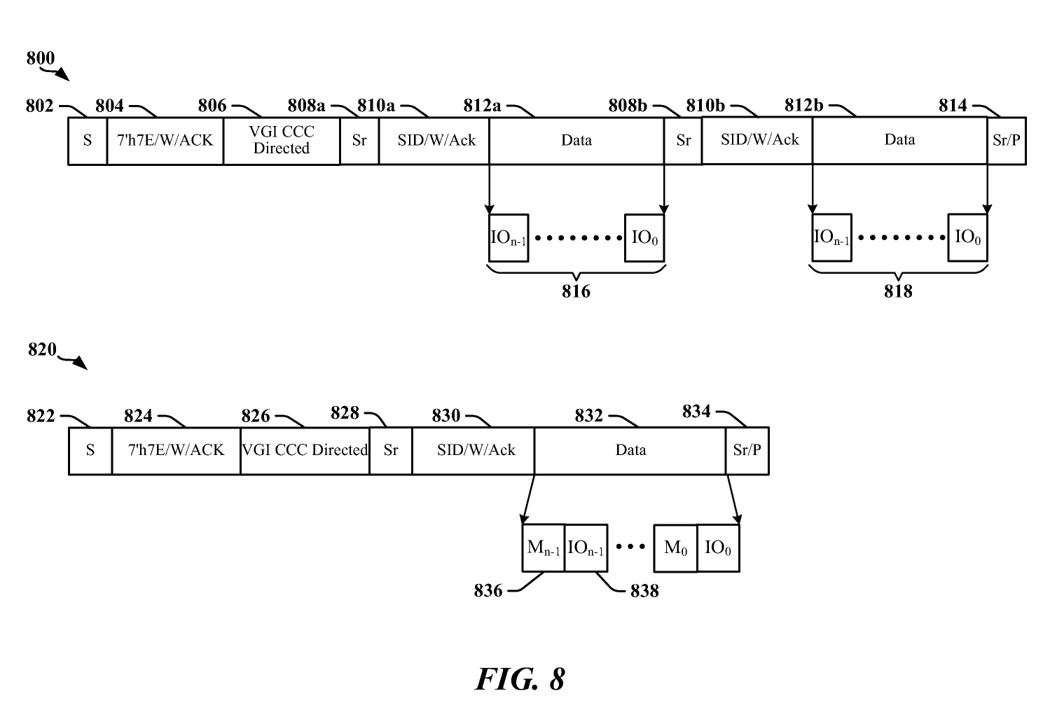

FIG. 8 illustrates examples of VGI directed frames 800, 820. In a first example, VGI directed frames 800 may be addressed to a single peripheral device or, in some instances, to a group of peripheral devices. The first of the VGI directed frames 800 commences with a start bit 802 (S) followed by a header 804 in accordance with an I2C or I3C protocol. A VGI directed frame 800 may be identified using a VGI directed common command code 806. The directed common command code 806 may be followed by a synchronization field 808a (Sr) and an address field 810a that includes a slave identifier to select the addressed device. The directed VGPIO data payload 812a that follows the address field 810a includes values 816 for a set of I/O signals that pertain to the addressed device. VGI directed frames 800 can include additional directed payloads 812b for additional devices. For example, the first directed VGPIO data payload 812a may be followed by a synchronization field 808b and a second address field 810b. In this example, the second directed VGPIO payload 812b includes values 818 for a set of I/O signals that pertain to a second addressed device. The use of VGI directed frames 800 may permit transmission of values for a subset or portion of the I/O signals carried in a broadcast VGPIO frame 700, 720.

In the second example, a masked VGI directed frame 820 may be transmitted by a host device to change the state of one or more GPIO pins without disturbing the state of other GPIO pins in a single peripheral device and without affecting other peripheral devices. In some examples, the I/O signals in one or more devices may be masked, while selected I/O signals in one or more targeted device are unmasked. The masked VGI directed frame 820 commences with a start bit 822 followed by a header 824. A masked VGI directed frame 820 may be identified using a masked VGI directed common command code 826. The masked VGI directed command code 826 may be followed by a synchronization field 828 (Sr) and an address field 830 that includes a slave identifier to select the addressed device. The directed payload 832 that follows includes VGPIO values for a set of I/O signals that pertain to the addressed device. For example, the VGPIO values in the directed data payload 832 may include I/O signal values 838 and corresponding mask bits 836.

A stop bit or synchronization bit (Sr/P 814, 834) terminates the VGI directed frames 800, 820. A synchronization bit may be transmitted to indicate that an additional VGPIO payload is to be transmitted. In one example, the synchronization bit may be a repeated start bit in an I2C interface.

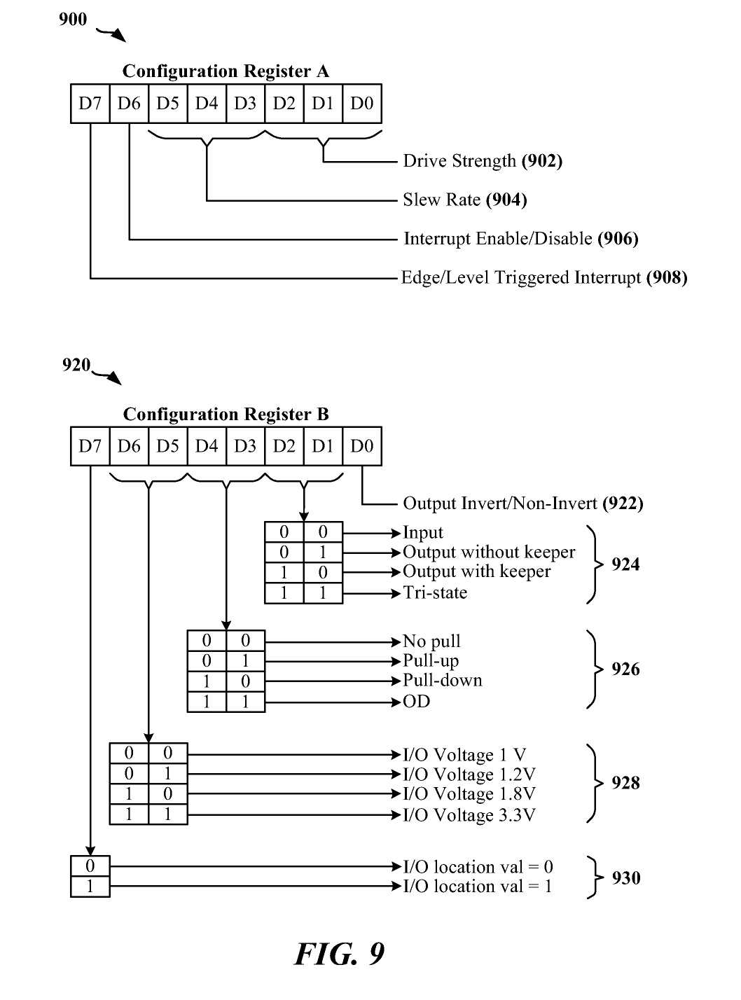

At the receiving device (e.g., the Application Processor 502 and/or peripheral device 504, 506, 508), received virtual GPIO signals are expanded into physical GPIO signal states presented on GPIO pins. The term “pin,” as used herein, may refer to a physical structure such as a pad, pin or other interconnecting element used to couple an IC to a wire, trace, through-hole via, or other suitable physical connector provided on a circuit board, substrate or the like. Each GPIO pin may be associated with one or more configuration registers that store configuration parameters for the GPIO pin. FIG. 9 illustrates configuration registers 900 and 920 that may be associated with a physical pin. Each configuration register 900, 920 is implemented as a one-byte (8 bits) register, where different bits or groups of bits define a characteristic or other features that can be controlled through configuration. In a first example, bits D0-D2 902 control the drive strength for the GPIO pin, bits D3-D5 904 control the slew rate for GPIO pin, bit D6 906 enables interrupts, and bit D7 908 determines whether interrupts are edge-triggered or triggered by voltage-level. In a second example, bit D0 922 selects whether the GPIO pin receives an inverted or non-inverted signal, bits D1-D2 924 define a type of input or output pin, bits D3-D4 926 defines certain characteristics of an undriven pin, bits D5-D6 928 define voltage levels for signaling states, and bit D7 930 controls the binary value for the GPIO pin (i.e., whether GPIO pin carries carry a binary one or zero).

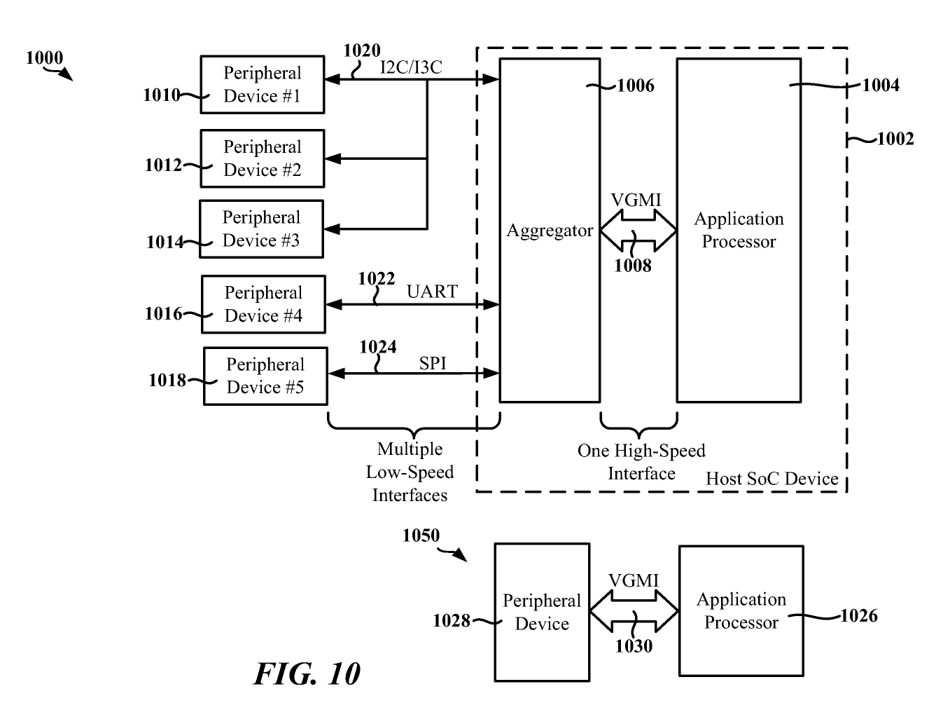

FIG. 10 illustrates a device 1000 including a host system-on-chip (SoC) device 1002 in communication with a number of peripheral devices 1010, 1012, 1014, 1016, and 1018. Although only five peripheral devices are shown in FIG. 10 for ease of illustration, it should be understood that a different number of peripheral devices may be implemented in other aspects. For example, one or more of the peripheral devices 1010, 1012, 1014, 1016, and 1018 may be a sensor device, such as a fingerprint sensor, an accelerometer, a magnetometer, a gyro sensor, an ambient light sensor (ALS), a proximity sensor, an altimeter, a compass, or a grip sensor. As shown in FIG. 10, the peripheral devices 1010, 1012, and 1014 may communicate with the host SoC device through the I2C/I3C bus 1020, the peripheral device 1016 may communicate with the host SoC device 1002 through the universal asynchronous receiver/transmitter (UART) interface 1022, and the peripheral devices 1018 may communicate with the host SoC device 1002 through the serial peripheral interface (SPI) 1024. As further shown in FIG. 10, the host SoC device 1002 may include an Application Processor 1004 and an aggregator 1006. The aggregator 1006 may communicate with the Application Processor using a VGMI interface 1008. Therefore, the aggregator 1006 may communicate with the peripheral devices 1010, 1012, 1014, 1016, and 1018 using multiple low speed interfaces (e.g., I2C/I3C, UART, and/or SPI), and may communicate with the Application Processor 1004 using one high speed interface (e.g., VGMI). In an aspect of the disclosure, the aggregator 1006 may be a low-speed sensor aggregator.

In one example, the peripheral device #2 1012 may be a finger-print sensor. Therefore, the peripheral device #2 1012 may need to transmit encrypted data to the host SoC device 1002. In the current VGMI protocol, the peripheral device #2 1012 may need to transmit two datagrams (e.g., two separate VGMI packets) to enable the receiver (e.g., the host SoC device 1002) to process the encrypted data. For instance, the peripheral device #2 1012 may transmit a first datagram (also referred to as a pilot message or a pilot packet) to the host SoC device 1002 to indicate that the next datagram from the peripheral device #2 1012 will contain encrypted data. In an aspect, the first datagram may access a specific register location to make such indication. The peripheral device #2 1012 may then transmit a second datagram that includes the encrypted data. Thus, the requirement of transmitting the first datagram adds to latency. This added latency may completely break the hard real-time requirement in certain applications.

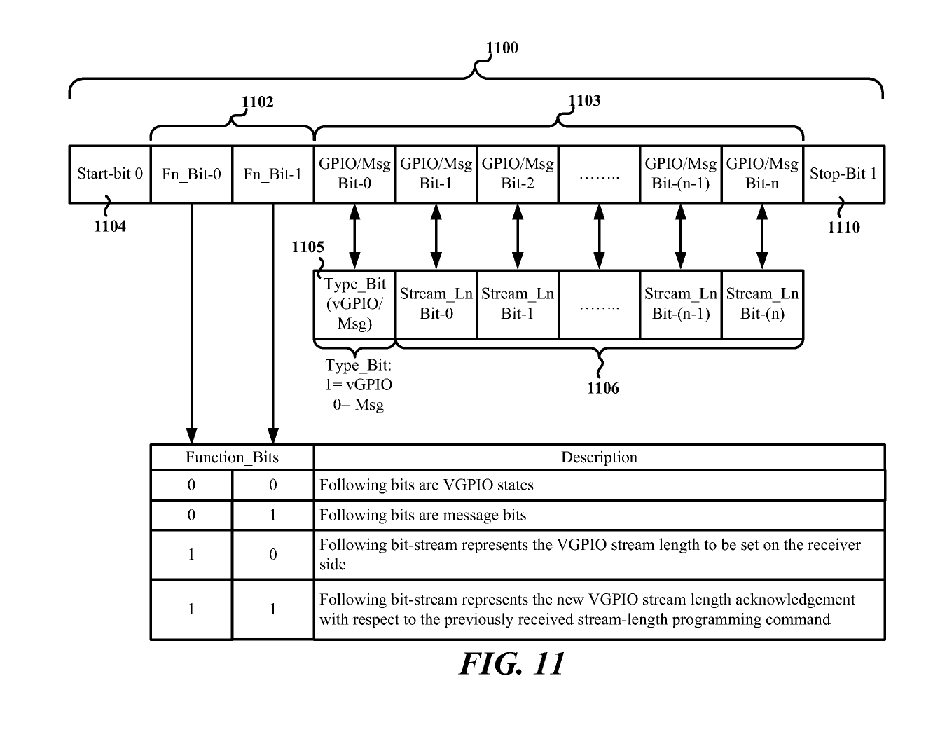

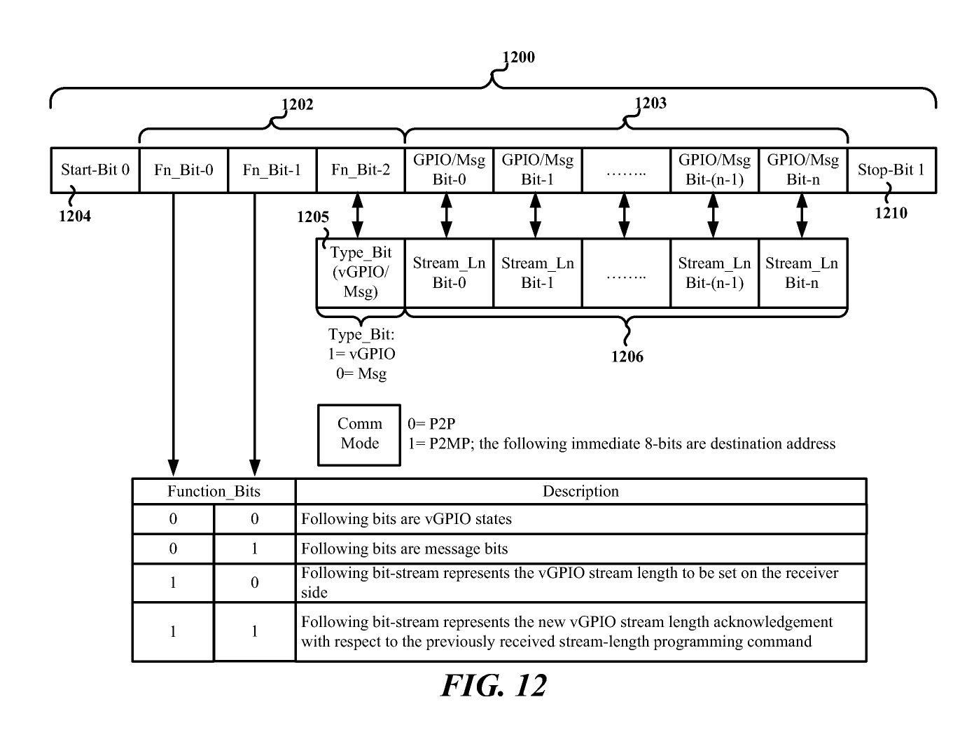

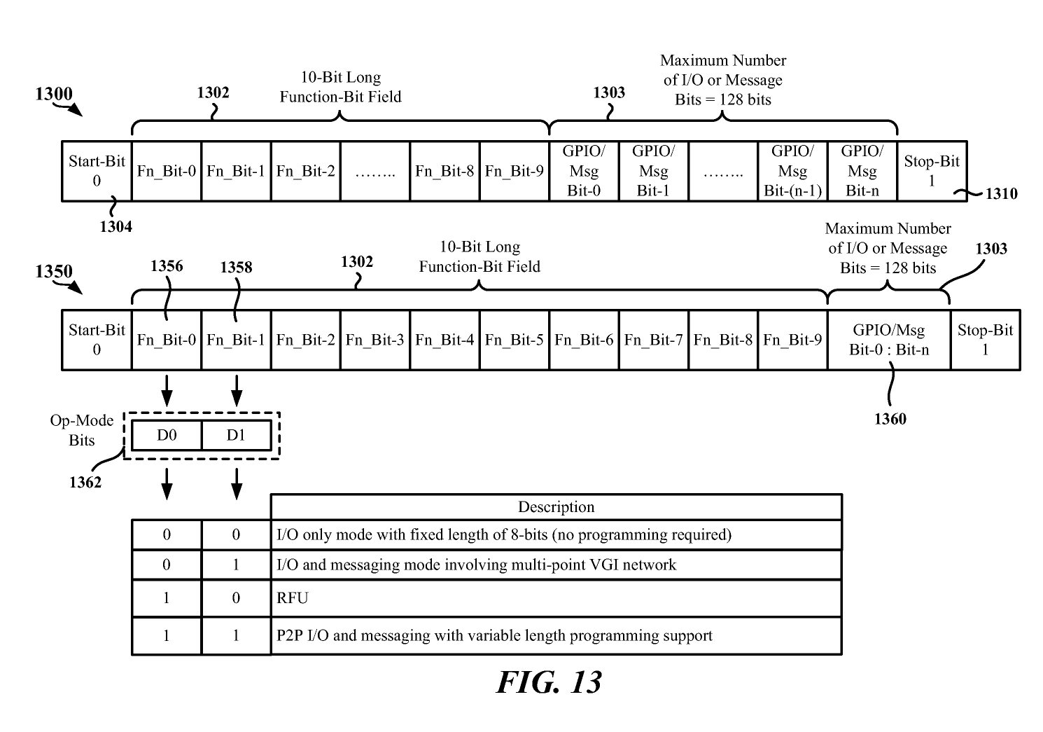

VGMI offers a scalable protocol. Therefore, in some aspects, multiple VGMI packet types may be defined and implemented for the communication of VGMI packets between two or more interconnected devices (e.g., the host SoC device 1002 and one or more of the peripheral devices 1010, 1012, 1014, 1016, and 1018). Examples of three such VGMI packet types are described herein with reference to FIGS. 11-13. For example, the VGMI packet 1100 in FIG. 11 may represent a Type-1 VGMI packet, the VGMI packet 1200 in FIG. 12 may represent a Type-2 VGMI packet, and the VGMI packet 1300 in FIG. 13 may represent a Type-3 VGMI packet. In some aspects, the Type-1 packet may be the default VGMI packet configuration following Power-On-Reset of one or more of the interconnected devices. In some aspects, switching between different protocols (e.g., VGMI packet types) may be performed by mutual agreement between the two interconnected devices.

FIG. 10 further illustrates a device 1050, which may include an application processor 1026 coupled to a peripheral device 1028. In an aspect, the application processor 1026 may communicate with the peripheral device 1028 (e.g., in a point-to-point configuration) using a VGMI interface 1030.

FIG. 11 shows an example VGMI packet 1100 for communication of VGPIO signals or message signals. The VGMI packet 1100 begins with a start bit 1104 and ends with a stop bit 1110. For example, start bit 1104 may be a logic ‘0’ (e.g., binary zero) and the stop bit 1110 may be a logic ‘1’ (e.g., binary one). A header 1102 may include two function bits (e.g., Fn_Bit-0 and Fn_Bit-1 in FIG. 11). The two function bits in the header 1102 (e.g., Fn_Bit-0 and Fn_Bit-1) may identify whether the subsequent payload 1103 contains VGPIO bits or message bits. In one embodiment, if both function bits are set to logic value ‘0’, the header 1102 identifies the VGMI packet 1100 as containing a VGPIO data payload (e.g., that the following bits are virtual GPIO signals). If the function bit Fn_Bit-0 is set to logic value ‘0’ and the function bit Fn_Bit-1 is set to logic value ‘1’, the header 1102 identifies the VGMI packet 1100 as containing a messaging data payload (e.g., that the following bits are messaging signals). If the function bit Fn_Bit-0 is set to logic value ‘1’ and the function bit Fn_Bit-1 is set to logic value ‘0’, then the following bits represent the virtual GPIO packet length to be expected by the receiving device (also referred to as a remote processor) for subsequent VGMI packets. If both function bits Fn_Bit-0 and Fn_Bit-1 are set to logic value ‘1’, the following bits represent an acknowledgement from the remote processor with respect to the previously received packet-length programming operation. It should be understood that the preceding discussion of coding using two function bits serves an example and that other headers and coding protocols may be used to identify whether a VGMI packet is carrying virtual GPIO signals, messaging signals, an identification of the VGMI packet length, and/or an acknowledgment of the VGMI packet length. In an aspect, the VGMI packet 1100 may also include a third function bit at GPIO/MSG Bit-0 (e.g., the Type_Bit 1105 in FIG. 11). Such third function bit may be associated with programming and acknowledgement packets. For example, in one aspect, the Type_Bit 1105 may be set to logic value ‘1’ to indicate packet length programming (also referred to as link length programming or steam-length programming) for virtual GPIO signals, and may be set to logic value ‘0’ to indicate packet length programming for messaging signals.

In one aspect of the disclosure, to program the length of the VGMI packet 1100, a transmitting VGI FSM (e.g., VGI FSM 610) may set the function bit Fn_Bit-0 to logic value ‘1’ and the function bit Fn_Bit-1 to logic value ‘0’ in the header 1102. The corresponding data payload (e.g., bits 1106 in FIG. 11) in the VGMI packet 1100 would then identify the new packet length. Should a receiving VGI FSM (e.g., VGI FSM 626) support this new packet length, such VGI FSM may transmit an acknowledgement VGMI packet 1100 in which header 1102 has the function bits Fn_Bit-0 and Fn_Bit-1 set to logic value ‘1’. The corresponding data payload (e.g., bits 1106 in FIG. 11) in such an acknowledgement VGMI packet would repeat the packet length identified by the previous programming VGMI packet.

It will be appreciated that variations of VGMI packet 1100 may be used in alternative aspects. However, regardless of the variation, the VGI FSM (e.g., VGI FSM 610, 626) may be preconfigured to decode the header and data payload in such alternative VGMI packet. In some aspects, the VGMI packet 1100 is implemented in point-to-point VGMI links.

FIG. 12 shows an example VGMI packet 1200 for communication of VGPIO signals or message signals. The VGMI packet 1200 begins with a start bit 1204 and ends with a stop bit 1210. For example, the start bit 1204 may be a logic ‘0’ (e.g., binary zero) and the stop bit 1210 may be a logic ‘1’ (e.g., binary one). A header 1202 may include three function bits (e.g., Fn_Bit-0, Fn_Bit-1, and Fn_Bit-2 in FIG. 12). The first two function bits in the header 1202 (e.g., Fn_Bit-0 and Fn_Bit-1) may identify whether the subsequent payload 1203 includes VGPIO bits or message bits. In one aspect, if both function bits Fn_Bit-0 and Fn_Bit-1 are set to logic value ‘0’, the header 1202 identifies the VGMI packet 1200 as containing a VGPIO data payload (e.g., that the following bits in payload 1203 are virtual GPIO signals). If the function bit Fn_Bit-0 is set to logic value ‘0’ and the function bit Fn_Bit-1 is set to logic value ‘1’, the header 1202 identifies the VGMI packet 1200 as containing a messaging data payload (e.g., that the following bits in the payload 1203 are messaging signals).

If the function bit Fn_Bit-0 is set to logic value ‘1’ and the function bit Fn_Bit-1 is set to logic value ‘0’, then the following bits in the payload 1203 (e.g., bits 1206 in FIG. 12) may represent the virtual GPIO packet length or message packet length to be expected by the remote processor during a packet length programming operation. For example, to program the length of the VGMI packet 1200, a transmitting VGI FSM (e.g., VGI FSM 610) may set the function bit Fn_Bit-0 to logic value ‘1’ and the function bit Fn_Bit-1 to logic value ‘0’ in the header 1202. The corresponding data payload (e.g., bits 1206 in FIG. 12) in the VGMI packet 1200 would then identify the new packet length. In an aspect, the function Fn_Bit-2 may be set to logic value ‘1’ to set the length of the virtual GPIO packet, or set to logic value ‘0’ to set the length of the message packet. Should a receiving VGI FSM (e.g., VGI FSM 626) support this new packet length, such VGI FSM may transmit an acknowledgement VGMI packet 1200 in which header 1202 has the function bits Fn_Bit-0 and Fn_Bit-1 set to logic value ‘1’. The corresponding data payload (e.g., bits 1206 in FIG. 12) in such an acknowledgement VGMI packet would repeat the packet length identified by the previous programming VGMI packet.

In one aspect of the disclosure, when both function bits Fn_Bit-0 and Fn_Bit-1 are set to logic value ‘0’, or when the function bit Fn_Bit-0 is set to logic value ‘0’ and the function bit Fn_Bit-1 is set to logic value ‘1’, the function indicated by the function bit Fn_Bit-2 may be based on the contents of a predetermined register. For example, if the predetermined register includes a first value, the function bit Fn_Bit-2 may be used as a virtual channel marker as discussed in detail herein. Otherwise, if the predetermined register includes a second value, the function bit Fn_Bit-2 may be used to indicate a communication mode. For example, when the function bit Fn_Bit-2 is set to logic value ‘0’, a point-to-point communication mode may be indicated, and when the function Fn_Bit-2 is set to logic value ‘1’, a point-to-multipoint communication mode may be indicated (e.g., that the following immediate 8-bits in the payload 1203 are a destination address).

It should be understood that the preceding discussion of coding using three function bits serves as an illustration and that other headers and coding protocols may be used to identify whether a VGMI packet is carrying virtual GPIO signals, messaging signals, an identification of the VGMI packet length, and/or an acknowledgment of the VGMI packet length. It will be appreciated that variations of VGMI packet 1200 may be used in alternative embodiments. However, regardless of the variation, the VGI FSM (e.g., VGI FSM 610, 626) may be preconfigured to decode the header and data payload in such alternative VGMI packet. In some aspects, the VGMI packet 1200 may be implemented in point-to-point VGMI links.

FIG. 13 shows an example VGMI packet 1300 for communication of VGPIO signals or message signals. The VGMI packet 1300 begins with a start bit 1304 and ends with a stop bit 1310. For example, the start bit 1304 may be a logic ‘0’ (e.g., binary zero) and the stop bit 1310 may be a logic ‘1’ (e.g., binary one). The VGMI packet 1300 may include a header 1302 (also referred to as a function bit field) that may include 10 function bits (e.g., Fn_Bit-0 to Fn_Bit-9 in FIG. 13). The VGMI packet 1300 may further include a payload 1303 that may include a number of virtual GPIO or message bits. In one aspect, the payload 1303 may include a maximum of 128 virtual GPIO bits or 128 message bits (e.g., GPIO/Msg Bit-0 to GPIO/Msg Bit-n in FIG. 13, where n<128).

The VGMI packet 1350 in FIG. 13 is an alternative representation of the previously described VGMI packet 1300, such that the VGMI packet 1350 depicts the maximum number of function bits (e.g., the 10 function bits Fn_Bit-0 to Fn_Bit-9) that may be used. As shown in the VGMI packet 1350, the first two function bits in the header 1302 (e.g., Fn_Bit-0 1356 and Fn_Bit-1 1358) may be used to set the operation mode. Therefore, in some aspects, the first two function bits 1356, 1358 in the header 1302 may serve as operation mode bits 1362 as shown in FIG. 13. In one aspect, if both of the function bits Fn_Bit-0 and Fn_Bit-1 are set to logic value ‘0’, the operation mode is an I/O only mode with a fixed length of 8-bits. In this case, programming of the length of the payload 1303 may not be required. If the function bit Fn_Bit-0 1356 is set to logic value ‘0’ and the function bit Fn_Bit-1 1358 is set to logic value ‘1’, the operation mode is an I/O and messaging mode involving a multipoint VGMI network. If both the function bits Fn_Bit-0 1356 and Fn_Bit-1 1358 are set to logic value ‘1’, the operation mode may be a point-to-point I/O and messaging mode with variable length programming support. The configuration where the function bit Fn_Bit-0 1356 is set to logic value ‘1’ and the function bit Fn_Bit-1 1358 is set to logic value ‘0’ may be reserved for other functions and/or operations. In some aspects of the disclosure, the remaining 8-bits (mode “10”) may be extended Hamming (8,4) coded 8-bit code words defining unique functions. Therefore, the VGMI packet 1350 in FIG. 13 may provide options for expansion to facilitate the addition of new functions.

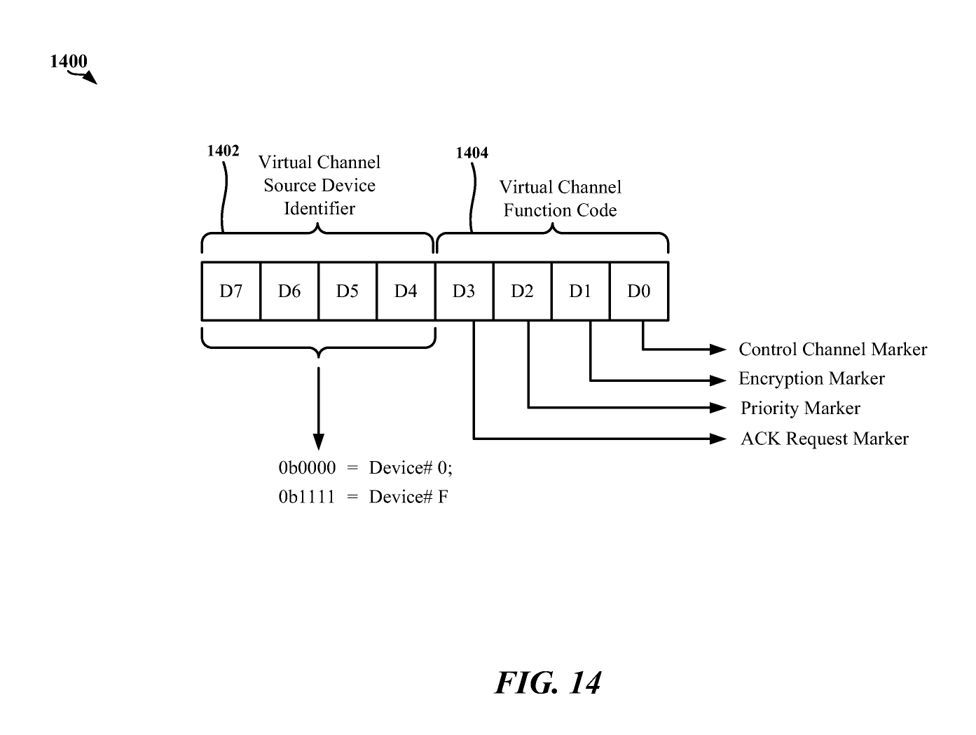

FIG. 14 shows an example configuration of a virtual channel identifier 1400 in accordance with various aspects of the disclosure. In one aspect of the disclosure, the virtual channel identifier 1400 may include a total of 8 bits (e.g., bits D0 to D7). For example, the bits D0 to D3 may indicate a virtual channel function code 1404, and the bits D4 to D7 may indicate a virtual channel source device identifier 1402.

As shown in FIG. 14, the four bits (e.g., bits D4 to D7) indicating the virtual channel source device identifier 1402 may be set to one of 16 binary values (e.g., 0000 to 1111), and each of the 16 binary values may correspond to one of 16 devices (e.g., Device#0 to Device# F). As further shown in FIG. 14, a first bit (e.g., bit D0) of the virtual channel function code 1404 may indicate a control channel marker, a second bit (e.g., bit D1) of the virtual channel function code 1404 may indicate an encryption marker, a third bit (e.g., bit D2) of the virtual channel function code 1404 may indicate a priority marker, and a fourth bit (e.g., bit D3) of the virtual channel function code 1404 may indicate an acknowledge (ACK) request marker. In an aspect of the present disclosure, and as described in detail herein, a first device may transmit the virtual channel identifier 1400 to a second device by including the bits D0 to D7 of the virtual channel identifier 1400 in the example VGMI packet 1200 previously described with respect to FIG. 12.

In an aspect, the encryption marker may be a bit that indicates whether or not data (or control information) in a VGMI packet is encrypted. For example, when the encryption marker bit is enabled (e.g., set to logic value ‘1’), the encryption marker bit may indicate that the data (or control information) in the VGMI packet is encrypted. Otherwise, when the encryption marker bit is disabled (e.g., set to logic value ‘0’), the encryption marker bit may indicate that the data (or control information) in the VGMI packet is not encrypted.

In an aspect, the control channel marker may be a bit that indicates whether the payload of a VGMI packet includes data or control information. For example, when the control channel marker bit is enabled (e.g., set to logic value ‘1’), the control channel marker bit may indicate that the VGMI packet includes control information. Otherwise, when the encryption marker bit is disabled (e.g., set to logic value ‘0’), the control channel marker bit may indicate that the VGMI packet includes data.

In an aspect, the ACK request marker may be a bit that indicates whether the receiver needs to send an acknowledgement in response to receiving the VGMI packet. For example, when the ACK request marker bit is enabled (e.g., set to logic value ‘1’), the ACK request marker bit may indicate that the receiver needs to send an acknowledgement in response to receiving the VGMI packet. Otherwise, when the ACK request marker bit is disabled (e.g., set to logic value ‘0’), the ACK request marker bit may indicate that the receiver does not need to send an acknowledgement in response to receiving the VGMI packet.

It should be noted that the term “virtual channel identifier” may be generalized as (or used interchangeably with) the term “data type.” For example, if a virtual channel is equal to a value “5”, the receiver may take action “x”, and if a data type is equal to a value “6”, the receiver may take a different action “y”. This also applies to a one-device to one-device (e.g., point-to-point) scenario, where for example, the single sending device may indicate that the next packet is encrypted in order for the receiver to know to decrypt. Accordingly, and as described herein, data or control information in a given VGMI packet may be processed differently at a receiving device based on the information in the virtual channel identifier.

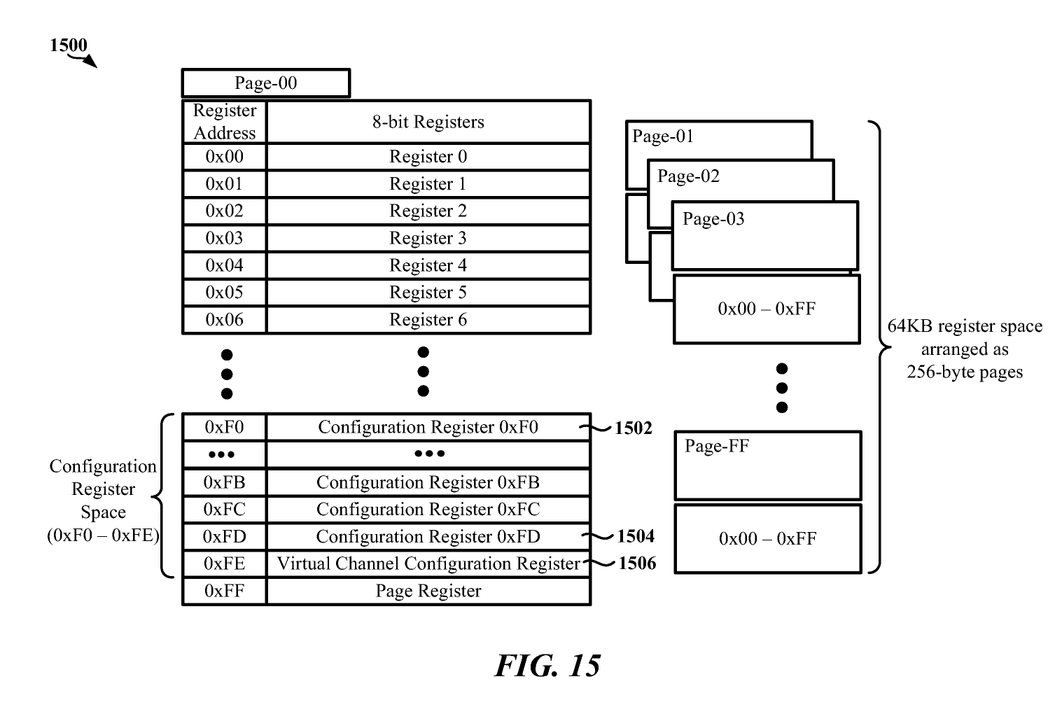

FIG. 15 shows an example implementation of a virtual channel configuration register in accordance with various aspects of the disclosure. As shown in FIG. 15, a 64 KB register space in a memory (e.g., a memory accessible by the interconnect devices) may be configured as 256-byte pages (e.g., pages 00 to FF). In other words, the 64 KB register space may be configured as 256 pages (e.g., page 00 to page FF), where each page includes 256 8-bit registers. As further shown in FIG. 15, certain 8-bit registers (e.g., 0xF0-0xFE) in a page (e.g., page 00 as shown in FIG. 15) may be designated as configuration registers. For example, the 8-bit register at register address 0xFE may serve as a virtual channel configuration register 1506.

In an aspect of the disclosure, the virtual channel configuration register 1506 may be set (e.g., by a transmitting device) to include a first value indicating that the function bit Fn_Bit-2 in the header 1202 may be used as a virtual channel marker, or may be set to include a second value indicating that the function bit Fn_Bit-2 in the header 1202 may be used to indicate a communication mode. For example, the first value may be 0b00000001 (e.g., the binary value ‘00000001’) and the second value may be 0b00000000 (e.g., the binary value ‘00000000’). In an aspect, the interconnected devices may be programmed to know the meaning assigned to the first value and the meaning assigned to the second value. In an aspect of the disclosure, with reference to the example VGMI packet 1200 in FIG. 12, when the virtual channel configuration register 1506 is set to the first value (e.g., 0b00000001), and the function bit Fn_Bit-2 in the header 1202 is enabled (e.g., set to logic value ‘1’) in a VGMI packet, then the eight bits in the payload 1203 immediately following the function bit Fn_Bit-2 may contain the virtual channel identifier 1400 described with respect to FIG. 14. In some aspects, the virtual channel configuration register 1506 may be cleared (e.g., disabled) upon Power-On-Reset of one or more of the interconnected devices. It should be understood that the location (e.g., register address) of the virtual channel configuration register 1506 in FIG. 15 is for illustrative purposes and that in other embodiments, one or more different locations may be used for the virtual channel configuration register 1506.

In some aspects, irrespective of the protocol (e.g., Type 1, 2, or 3 VGMI packet type) and/or the mode (1-Wire, 2-Wire, 3-Wire, pulse width modulation (PWM), phase modulated-pulse width modulation (PM-PWM), UART, etc.), the locations of configuration registers (e.g., the configuration register addresses) such as configuration registers 1502, 1504, 1506, and their functions (e.g., the meanings assigned to the configuration registers) may not change. For example, such locations of configuration registers and/or their functions may be defined in the VGMI specification. In some aspects, register access may always be register-address based. In some aspects, changes to the virtual channel mode may be performed by accessing the virtual channel configuration register with mutual agreement of register bit values between the two devices (e.g., the previously described first device and the second device).

### Example Datagram Using Virtual Channel Instantiation

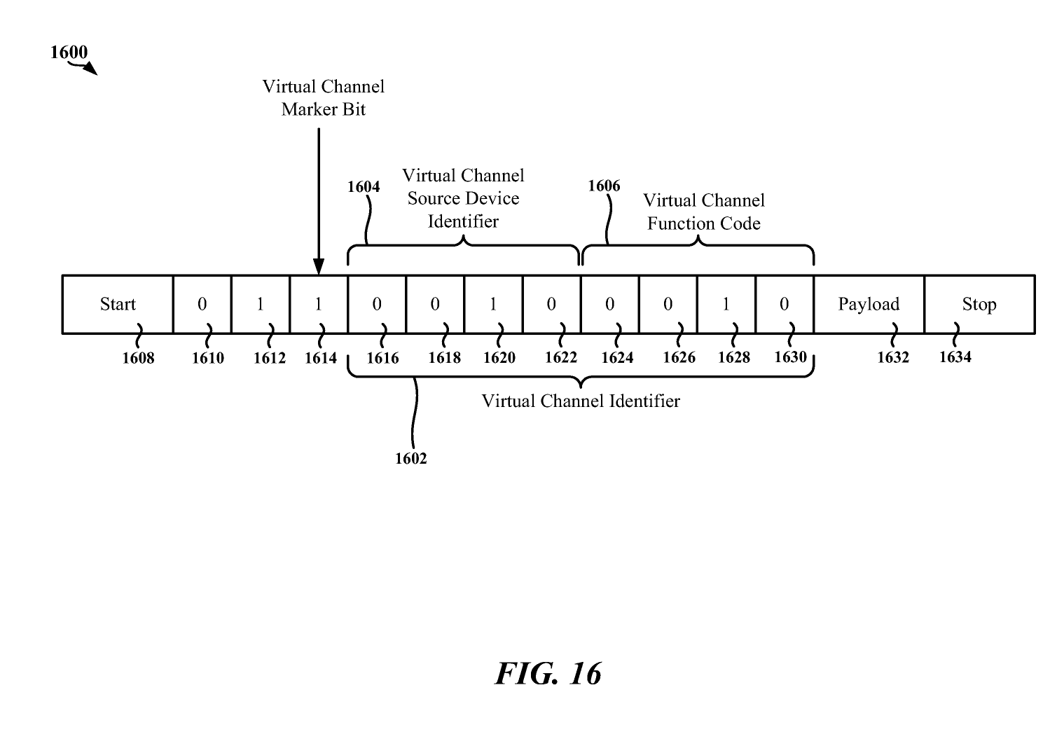

FIG. 16 shows an example of a VGMI packet 1600 implementing virtual channel instantiation in accordance with various aspects of the disclosure. For example, a first device (e.g., peripheral device #2 1012 in FIG. 10) may use the VGMI packet 1600 to send a datagram to a second device (e.g., Application Processor 1004 in FIG. 10). The example VGMI packet 1600 implementing virtual channel instantiation may be based on the configuration of the example VGMI packet 1200 described with respect to FIG. 12. As shown in FIG. 16, the first device may configure the VGMI packet 1600 to include a start bit 1608, a function bit Fn_Bit-0 1610 set to logic value ‘0’, and a function bit Fn_Bit-1 1612 set to logic value ‘1’. If the previously described virtual channel configuration register (e.g., the virtual channel configuration register 1506 in FIG. 15) is set to a first value (e.g., 0b00000001) indicating that the function bit Fn_Bit-2 1614 may be used as a virtual channel marker bit, the first device may instantiate the virtual channel by enabling the function bit Fn_Bit-2 1614 (e.g., by setting the function bit Fn_Bit-2 1614 to logic value ‘1’) as shown in FIG. 16. When the function bit Fn_Bit-2 1614 serves as a virtual channel marker bit and is enabled, the following 8 bits (e.g., bit 1616 to bit 1630 in FIG. 16) in the VGMI packet 1600 may include a virtual channel identifier 1602. For example, the virtual channel identifier 1602 may be configured as the virtual channel identifier 1400 described with respect to FIG. 14. Accordingly, the bits 1616, 1618, 1620, and 1622 may represent a virtual channel source device identifier 1604, and the bits 1624, 1626, 1628, and 1630 may represent a virtual channel function code 1606. For example, and as shown in the configuration of FIG. 16, if the first device is the peripheral device #2 1012 in FIG. 10 and is assigned the device identifier ‘0010’, the first device may set the bits 1616, 1618, 1620, and 1622 so as to represent the binary value ‘0010’. In another example, if the first device is the peripheral device #3 1014 in FIG. 10 and is assigned the device identifier ‘0011’, the first device may set the bits 1616, 1618, 1620, and 1622 so as to represent the binary value ‘0011’. Therefore, in one aspect, the bits 1616, 1618, 1620, and 1622 representing the virtual channel source device identifier 1604 may enable a second device (e.g., Application Processor 1004 in FIG. 10) receiving the VGMI packet 1600 to identify the sender of the VGMI packet 1600. In some aspects, the virtual channel identifier 1602 may enable the aggregator 1006 to conduct point-to-point communications, as well as point-to-multipoint communications.

As further shown in FIG. 16, the first device (e.g., peripheral device #2 1012 in FIG. 10) may configure the bits 1624, 1626, 1628, and 1630 representing the virtual channel function code 1606. In one aspect, the bits 1624, 1626, 1628, and 1630 may respectively correspond to the bits D3, D2, D1, and D0 in the virtual channel identifier 1400 described with respect to FIG. 14. Accordingly, the bit 1630 of the virtual channel function code 1606 may indicate a control channel marker, the bit 1628 (e.g., bit D1) of the virtual channel function code 1606 may indicate an encryption marker, the bit 1626 (e.g., bit D2) of the virtual channel function code 1606 may indicate a priority marker, and the bit 1624 (e.g., bit D3) of the virtual channel function code 1606 may indicate an acknowledge (ACK) request marker. As shown in the configuration of FIG. 16, for example, when the first device is to transmit encrypted data in the payload 1632 of the VGMI packet 1600, the first device may enable the bit 1628 (e.g., set the bit 1628 to logic value ‘1’) representing the encryption maker to indicate to a second device (e.g., Application Processor 1004 in FIG. 10) receiving the VGMI packet 1600 that the payload 1632 includes encrypted data. Therefore, by implementing the previously described virtual channel identifier in the VGMI packet 1600 and the virtual channel configuration register 1504, the need to transmit two separate datagrams when transmitting encrypted data may be avoided. As a result, the latency experienced from the transmission of two separate datagrams may be reduced.

In some aspects, the payload 1632 may include one byte of address information followed by one or more consecutive bytes of data. In such aspect, the receiver may write the first data byte following the address information to the address of a memory space, and may write each subsequent data byte to the next higher address of the memory space.

With reference to the application processor 1026 and the peripheral device 1028 in FIG. 10, it should be noted that in some aspects, the previously described virtual channel or a device type may identify (e.g., dynamically on a per transaction basis) the peripheral device (e.g., the peripheral device 1028), and its interface or payload type (e.g. encrypted).

### First Exemplary Device and Method

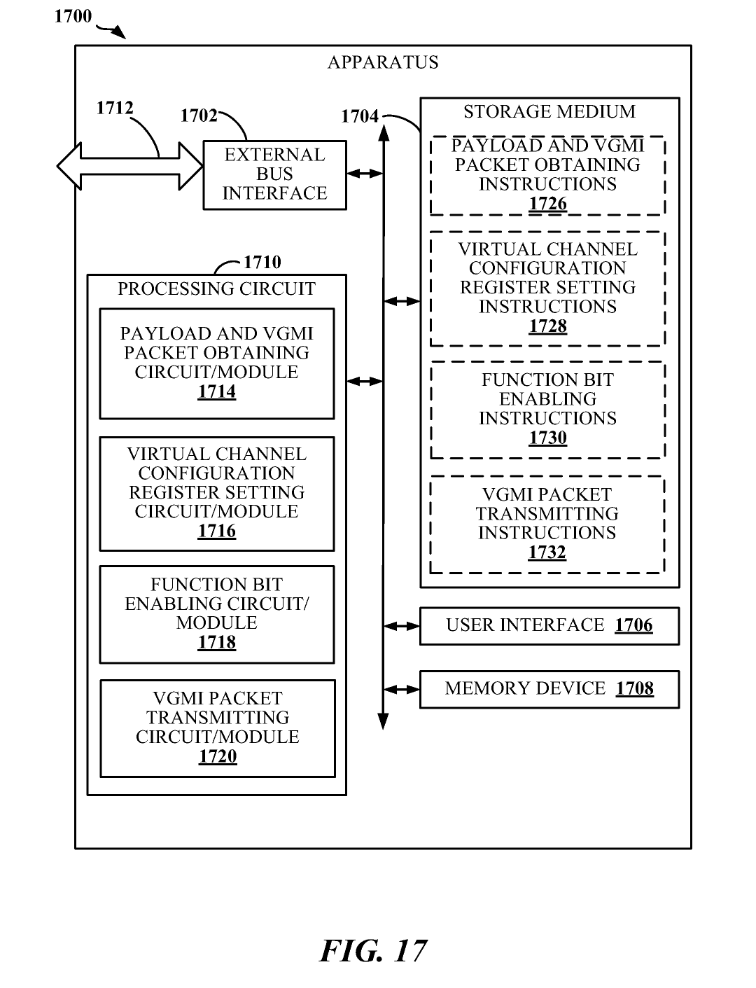

FIG. 17 is block diagram illustrating select components of an apparatus 1700 according to at least one example of the disclosure. The apparatus 1700 includes an external bus interface (or communication interface circuit) 1702, a storage medium 1704, a user interface 1706, a memory device 1708, and a processing circuit 1710. The processing circuit 1710 is coupled to or placed in electrical communication with each of the external bus interface 1702, the storage medium 1704, the user interface 1706, and the memory device 1708.

The external bus interface 1702 provides an interface for the components of the apparatus 1700 to an external bus 1712. The external bus interface 1702 may include, for example, one or more of: signal driver circuits, signal receiver circuits, amplifiers, signal filters, signal buffers, or other circuitry used to interface with a signaling bus or other types of signaling media. In an aspect, the external bus 1712 may include three physical interconnect lines (e.g., the communication link 622 in FIG. 6) for transmitting and receiving VGMI signals and/or I3C signals.

The processing circuit 1710 is arranged to obtain, process and/or send data, control data access and storage, issue commands, and control other desired operations. The processing circuit 1710 may include circuitry adapted to implement desired programming provided by appropriate media in at least one example. In some instances, the processing circuit 1710 may include circuitry adapted to perform a desired function, with or without implementing programming By way of example, the processing circuit 1710 may be implemented as one or more processors, one or more controllers, and/or other structure configured to execute executable programming and/or perform a desired function. Examples of the processing circuit 1710 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1710 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1710 are for illustration and other suitable configurations within the scope of the disclosure are also contemplated.

The processing circuit 1710 is adapted for processing, including the execution of programming, which may be stored on the storage medium 1704. As used herein, the terms “programming” or “instructions” shall be construed broadly to include without limitation instruction sets, instructions, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 1710 may include one or more of: a payload and VGMI packet obtaining circuit/module 1714, a virtual channel configuration register setting circuit/module 1716, a function bit enabling circuit/module 1718, or a VGMI packet transmitting circuit/module 1720.

The data and VGMI packet obtaining circuit/module 1714 may include circuitry and/or instructions (e.g., payload and VGMI packet obtaining instructions 1726 stored on the storage medium 1704) adapted to obtain a payload to be transmitted to a receiver device and/or obtain a virtual general-purpose input/output and messaging interface packet that includes at least the payload, a virtual channel identifier, and a function bit configured as a virtual channel marker bit to indicate that the virtual general-purpose input/output and messaging interface packet includes the virtual channel identifier, wherein the virtual channel identifier indicates information associated with processing the payload. The virtual channel configuration register setting circuit/module 1716 may include circuitry and/or instructions (e.g., virtual channel configuration register setting instructions 1728 stored on the storage medium 1704) adapted to set a virtual channel configuration register to indicate that the function bit in the virtual general-purpose input/output and messaging interface packet is configured as the virtual channel marker bit.

The function bit enabling circuit/module 1718 may include circuitry and/or instructions (e.g., function bit enabling instructions 1730 stored on the storage medium 1704) adapted to enable the function bit in the virtual general-purpose input/output and messaging interface packet.

The VGMI packet transmitting circuit/module 1720 may include circuitry and/or instructions (e.g., VGMI packet transmitting instructions 1732 stored on the storage medium 1704) adapted to transmit the virtual general-purpose input/output and messaging interface packet to the receiver device.

The storage medium 1704 may represent one or more processor-readable devices for storing programming, electronic data, databases, or other digital information. The storage medium 1704 may also be used for storing data that is manipulated by the processing circuit 1710 when executing programming. The storage medium 1704 may be any available media that can be accessed by the processing circuit 1710, including portable or fixed storage devices, optical storage devices, and various other mediums capable of storing, containing and/or carrying programming By way of example and not limitation, the storage medium 1704 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof. Thus, in some implementations, the storage medium may be a non-transitory (e.g., tangible) storage medium.

The storage medium 1704 may be coupled to the processing circuit 1710 such that the processing circuit 1710 can read information from, and write information to, the storage medium 1704. That is, the storage medium 1704 can be coupled to the processing circuit 1710 so that the storage medium 1704 is at least accessible by the processing circuit 1710, including examples where the storage medium 1704 is integral to the processing circuit 1710 and/or examples where the storage medium 1704 is separate from the processing circuit 1710.

Programming/instructions stored by the storage medium 1704, when executed by the processing circuit 1710, causes the processing circuit 1710 to perform one or more of the various functions and/or process steps described herein. For example, the storage medium 1704 may include one or more of: payload and VGMI packet obtaining instructions 1726, virtual channel configuration register setting instructions 1728, function bit enabling instructions 1730. Thus, according to one or more aspects of the disclosure, the processing circuit 1710 is adapted to perform (in conjunction with the storage medium 1704) any or all of the processes, functions, steps and/or routines for any or all of the apparatuses described herein. As used herein, the term “adapted” in relation to the processing circuit 1710 may refer to the processing circuit 1710 being one or more of configured, employed, implemented, and/or programmed (in conjunction with the storage medium 1704) to perform a particular process, function, step and/or routine according to various features described herein.

The memory device 1708 may represent one or more memory devices and may comprise any of the memory technologies listed above or any other suitable memory technology. The memory device 1708 may store information used by one or more of the components of the apparatus 1700. The memory device 1708 also may be used for storing data that is manipulated by the processing circuit 1710 or some other component of the apparatus 1700. In some implementations, the memory device 1708 and the storage medium 1704 are implemented as a common memory component.

The user interface 1706 includes functionality that enables a user to interact with the apparatus 1700. For example, the user interface 1706 may interface with one or more user output devices (e.g., a display device, etc.) and one or more user input devices (e.g., a keyboard, a tactile input device, etc.).

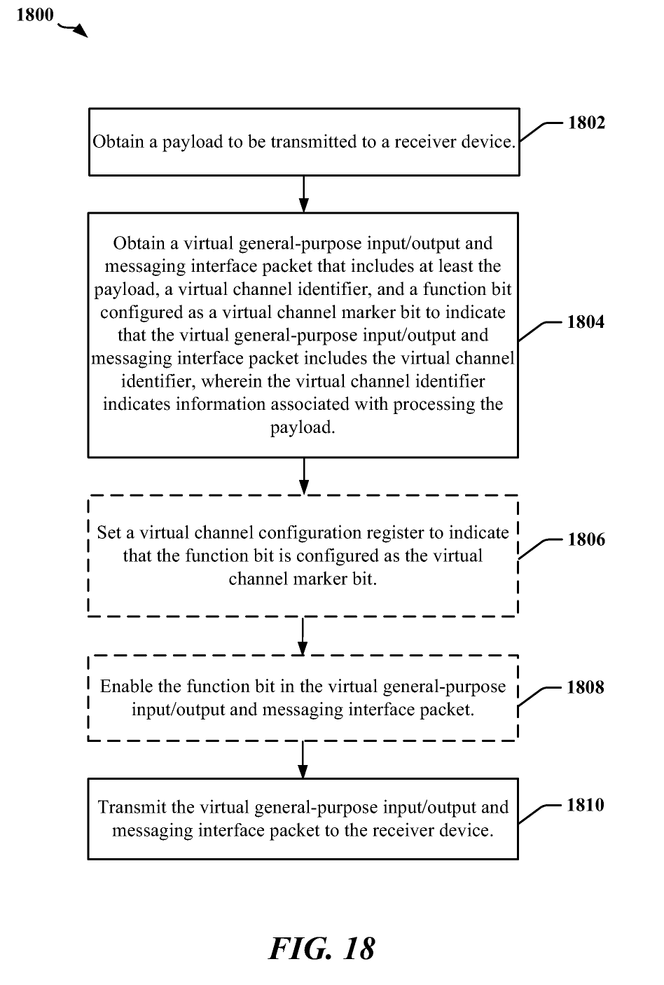

With the above in mind, examples of operations according to the disclosed aspects will be described in more detail in conjunction with the flowchart of FIG. 18. For convenience, the operations of FIG. 18 (or any other operations discussed or taught herein) may be described as being performed by specific components. It should be appreciated, however, that in various implementations these operations may be performed by other types of components and may be performed using a different number of components. It also should be appreciated that one or more of the operations described herein may not be employed in a given implementation.

FIG. 18 is a flowchart 1800 illustrating a method for an apparatus (e.g., the peripheral device #1 1010 in FIG. 10). For example, the apparatus may be a transmitter device. It should be understood that the operations in FIG. 18 represented with dashed lines represent optional operations.

With reference to FIG. 18, the apparatus obtains a payload to be transmitted to a receiver device 1802. For example, the payload may include data or control information. The apparatus obtains a virtual general-purpose input/output and messaging interface packet that includes at least the payload, a virtual channel identifier, and a function bit configured as a virtual channel marker bit to indicate that the virtual general-purpose input/output and messaging interface packet includes the virtual channel identifier, wherein the virtual channel identifier indicates information associated with processing the payload 1804. The apparatus sets a virtual channel configuration register to indicate that the function bit in the virtual general-purpose input/output and messaging interface packet is configured as a virtual channel marker bit 1806. The apparatus enables the function bit in the virtual general-purpose input/output and messaging interface packet 1808. The apparatus transmits the virtual general-purpose input/output and messaging interface packet to the receiver device 1810. In an aspect of the disclosure, the virtual channel identifier includes a virtual channel source device identifier that identifies the transmitter device, and a virtual channel function code that indicates the information associated with processing the payload. In an aspect of the disclosure, the virtual channel function code includes at least a control channel marker bit, an encryption marker bit, a priority marker bit, or an acknowledge request marker bit. In an aspect of the disclosure, the virtual channel identifier is included in a byte following the enabled function bit in the virtual general-purpose input/output and messaging interface packet. In an aspect of the disclosure, the virtual general-purpose input/output and messaging interface packet is transmitted to the receiver device over an I2C or I3C bus. In an aspect of the disclosure, the payload included in the virtual general-purpose input/output and messaging interface packet is encrypted, and an encryption marker bit in the virtual channel identifier is enabled to indicate that the payload is encrypted.

### Second Exemplary Device and Method

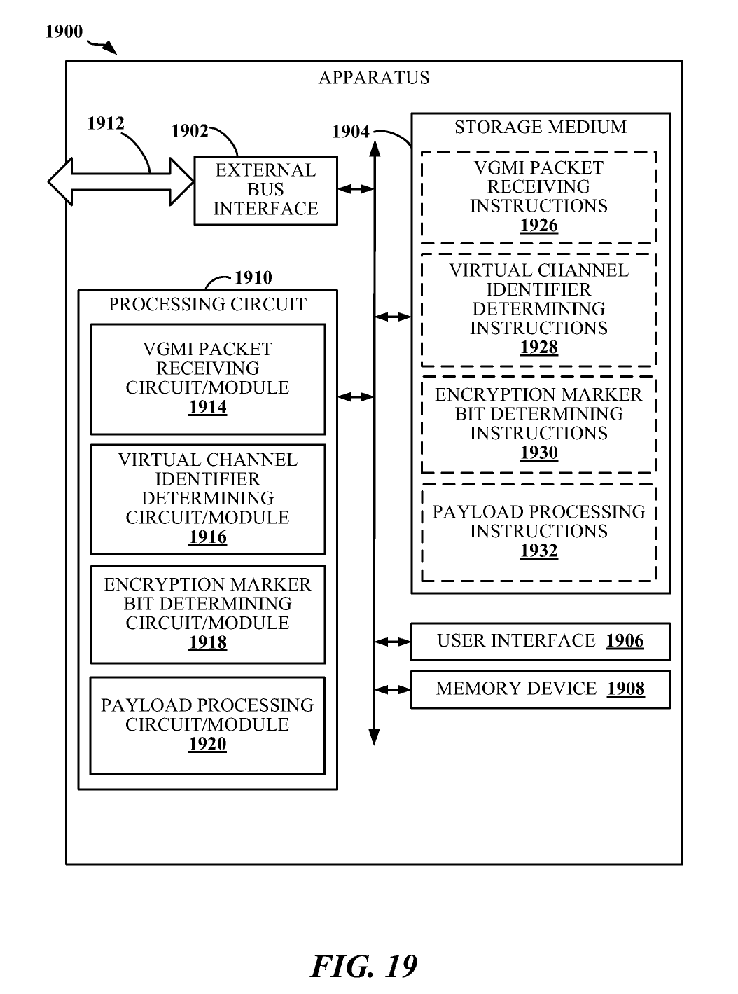

FIG. 19 is block diagram illustrating select components of an apparatus 1900 according to at least one example of the disclosure. The apparatus 1900 includes an external bus interface (or communication interface circuit) 1902, a storage medium 1904, a user interface 1906, a memory device 1908, and a processing circuit 1910. The processing circuit 1910 is coupled to or placed in electrical communication with each of the external bus interface 1902, the storage medium 1904, the user interface 1906, and the memory device 1908.

The external bus interface 1902 provides an interface for the components of the apparatus 1900 to an external bus 1912. The external bus interface 1902 may include, for example, one or more of: signal driver circuits, signal receiver circuits, amplifiers, signal filters, signal buffers, or other circuitry used to interface with a signaling bus or other types of signaling media. In an aspect, the external bus 1912 may include three physical interconnect lines (e.g., the communication link 622 in FIG. 6) for transmitting and receiving VGMI signals and/or I3C signals.

The processing circuit 1910 is arranged to obtain, process and/or send data, control data access and storage, issue commands, and control other desired operations. The processing circuit 1910 may include circuitry adapted to implement desired programming provided by appropriate media in at least one example. In some instances, the processing circuit 1910 may include circuitry adapted to perform a desired function, with or without implementing programming By way of example, the processing circuit 1910 may be implemented as one or more processors, one or more controllers, and/or other structure configured to execute executable programming and/or perform a desired function. Examples of the processing circuit 1910 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1910 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1910 are for illustration and other suitable configurations within the scope of the disclosure are also contemplated.

The processing circuit 1910 is adapted for processing, including the execution of programming, which may be stored on the storage medium 1904. As used herein, the terms “programming” or “instructions” shall be construed broadly to include without limitation instruction sets, instructions, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 1910 may include one or more of: a VGMI packet receiving circuit/module 1914, a virtual channel identifier determining circuit/module 1916, an encryption marker bit determining circuit/module 1918, or a payload processing circuit/module 1920.

The VGMI packet receiving circuit/module 1914 may include circuitry and/or instructions (e.g., VGMI packet receiving instructions 1926 stored on the storage medium 1904) adapted to receive a virtual general-purpose input/output and messaging interface packet from a transmitter device, wherein the virtual general-purpose input/output and messaging interface packet includes at least a payload and a virtual channel identifier.

The virtual channel identifier determining circuit/module 1916 may include circuitry and/or instructions (e.g., virtual channel identifier determining instructions 1928 stored on the storage medium 1904) adapted to determine that the virtual general-purpose input/output and messaging interface packet includes the virtual channel identifier based on a function bit configured as a virtual channel marker bit, wherein the virtual channel identifier indicates information associated with processing the payload.

The encryption marker bit determining circuit/module 1918 may include circuitry and/or instructions (e.g., encryption marker bit determining instructions 1930 stored on the storage medium 1904) adapted to determine that an encryption marker bit in the virtual channel identifier is enabled, the enabled encryption marker bit indicating that the payload is encrypted.

The payload processing circuit/module 1920 may include circuitry and/or instructions (e.g., payload processing instructions 1932 stored on the storage medium 1904) adapted to process the payload based on the information.

The storage medium 1904 may represent one or more processor-readable devices for storing programming, electronic data, databases, or other digital information. The storage medium 1904 may also be used for storing data that is manipulated by the processing circuit 1910 when executing programming. The storage medium 1904 may be any available media that can be accessed by the processing circuit 1910, including portable or fixed storage devices, optical storage devices, and various other mediums capable of storing, containing and/or carrying programming By way of example and not limitation, the storage medium 1904 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof. Thus, in some implementations, the storage medium may be a non-transitory (e.g., tangible) storage medium.

The storage medium 1904 may be coupled to the processing circuit 1910 such that the processing circuit 1910 can read information from, and write information to, the storage medium 1904. That is, the storage medium 1904 can be coupled to the processing circuit 1910 so that the storage medium 1904 is at least accessible by the processing circuit 1910, including examples where the storage medium 1904 is integral to the processing circuit 1910 and/or examples where the storage medium 1904 is separate from the processing circuit 1910.

Programming/instructions stored by the storage medium 1904, when executed by the processing circuit 1910, causes the processing circuit 1910 to perform one or more of the various functions and/or process steps described herein. For example, the storage medium 1904 may include one or more of: VGMI packet receiving instructions 1926, virtual channel identifier determining instructions 1928, encryption marker bit determining instructions 1930, payload processing instructions 1932. Thus, according to one or more aspects of the disclosure, the processing circuit 1910 is adapted to perform (in conjunction with the storage medium 1904) any or all of the processes, functions, steps and/or routines for any or all of the apparatuses described herein. As used herein, the term “adapted” in relation to the processing circuit 1910 may refer to the processing circuit 1910 being one or more of configured, employed, implemented, and/or programmed (in conjunction with the storage medium 1904) to perform a particular process, function, step and/or routine according to various features described herein.

The memory device 1908 may represent one or more memory devices and may comprise any of the memory technologies listed above or any other suitable memory technology. The memory device 1908 may store information used by one or more of the components of the apparatus 1900. The memory device 1908 also may be used for storing data that is manipulated by the processing circuit 1910 or some other component of the apparatus 1900. In some implementations, the memory device 1908 and the storage medium 1904 are implemented as a common memory component.

The user interface 1906 includes functionality that enables a user to interact with the apparatus 1900. For example, the user interface 1906 may interface with one or more user output devices (e.g., a display device, etc.) and one or more user input devices (e.g., a keyboard, a tactile input device, etc.).

With the above in mind, examples of operations according to the disclosed aspects will be described in more detail in conjunction with the flowchart of FIG. 18. For convenience, the operations of FIG. 18 (or any other operations discussed or taught herein) may be described as being performed by specific components. It should be appreciated, however, that in various implementations these operations may be performed by other types of components and may be performed using a different number of components. It also should be appreciated that one or more of the operations described herein may not be employed in a given implementation.

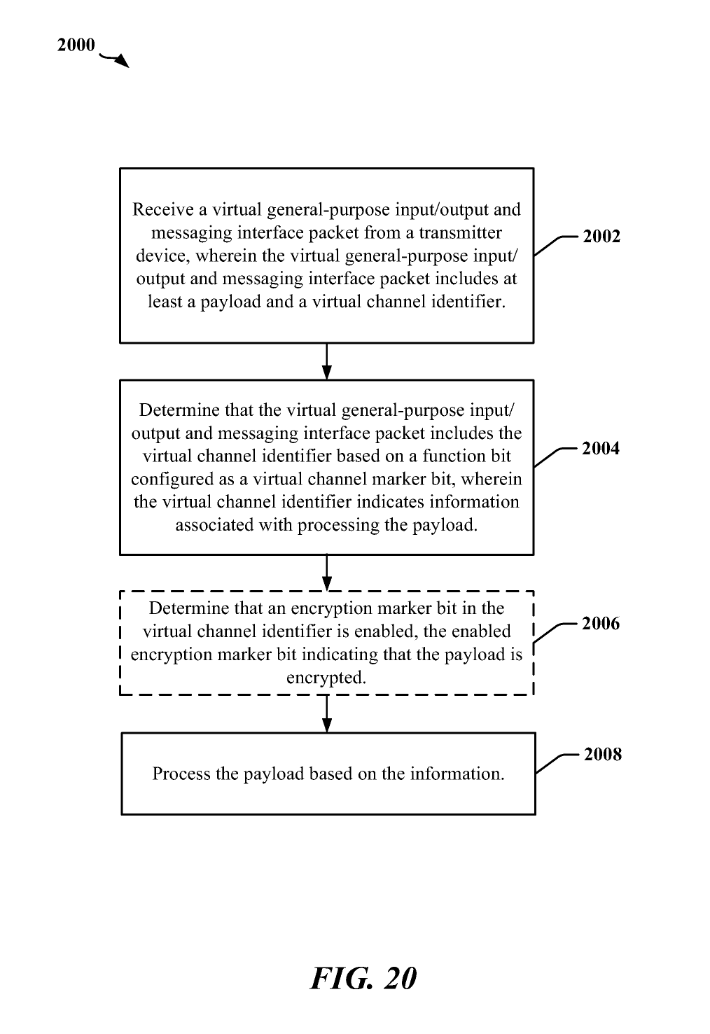

FIG. 20 is a flowchart 2000 illustrating a method for an apparatus (e.g., the host SoC 1002 in FIG. 10). For example, the apparatus may be a receiver device. It should be understood that the operations in FIG. 20 represented with dashed lines represent optional operations.

The apparatus receives a virtual general-purpose input/output and messaging interface packet from a transmitter device, wherein the virtual general-purpose input/output and messaging interface packet includes at least a payload and a virtual channel identifier 2002. The apparatus determines that the virtual general-purpose input/output and messaging interface packet includes the virtual channel identifier based on a function bit configured as a virtual channel marker bit, wherein the virtual channel identifier indicates information associated with processing the payload 2004. For example, the payload can include data or control information. For example, the function bit may be included in the VGMI packet. In an aspect, the apparatus may make this determination by determining that a virtual channel configuration register indicates that the function bit in the virtual general-purpose input/output and messaging interface packet is configured as a virtual channel marker bit, and determining that the function bit in the virtual general-purpose input/output and messaging interface packet is enabled. The apparatus determines that an encryption marker bit in the virtual channel identifier is enabled, the enabled encryption marker bit indicating that the payload is encrypted 2006. The apparatus processes the payload based on the information 2008. In some aspects of the disclosure, the virtual channel identifier includes a virtual channel source device identifier that identifies the transmitter device, and a virtual channel function code that indicates the information associated with processing the payload. In an aspect of the disclosure, the virtual channel function code includes at least a control channel marker bit, an encryption marker bit, a priority marker bit, or an acknowledge request marker bit. In an aspect of the disclosure, the virtual channel identifier is included in a byte following the enabled function bit in the virtual general-purpose input/output and messaging interface packet. In an aspect of the disclosure, the virtual general-purpose input/output and messaging interface packet is received over an I2C or I3C bus. In an aspect of the disclosure, when the payload included in the virtual general-purpose input/output and messaging interface packet is encrypted, the encryption marker bit in the virtual channel identifier is enabled to indicate that the payload is encrypted.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

While features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while exemplary implementations may have been discussed herein as device, system, or method implementations, it should be understood that such exemplary implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. In some aspects, a process may correspond to a method, a function, a procedure, a subroutine, a subprogram, etc. When a process corresponds to a function, its termination corresponds to a return of the function to the calling function or the main function. One or more of the various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like. As used herein, the term “obtaining” may include one or more actions including, but not limited to, receiving, generating, determining, or any combination thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method, comprising:
obtaining, at a transmitter device, a payload to be transmitted to a receiver device;
obtaining, at the transmitter device, a virtual general-purpose input/output and messaging interface packet that includes at least the payload, a virtual channel identifier, and a function bit configured as a virtual channel marker bit to indicate that the virtual general-purpose input/output and messaging interface packet includes the virtual channel identifier, wherein the virtual channel identifier indicates information associated with processing the payload; and
transmitting the virtual general-purpose input/output and messaging interface packet to the receiver device.

2. The method of claim 1, further comprising:
setting a virtual channel configuration register to indicate that the function bit is configured as the virtual channel marker bit; and
enabling the function bit in the virtual general-purpose input/output and messaging interface packet.

3. The method of claim 1, wherein the virtual channel identifier includes:
a virtual channel source device identifier that identifies the transmitter device; and
a virtual channel function code that indicates the information associated with processing the payload.

4. The method of claim 3, wherein the virtual channel function code includes at least a control channel marker bit, an encryption marker bit, a priority marker bit, or an acknowledge request marker bit.

5. The method of claim 2, wherein the virtual channel identifier is included in a byte following the enabled function bit in the virtual general-purpose input/output and messaging interface packet.

6. The method of claim 1, wherein the virtual general-purpose input/output and messaging interface packet is transmitted to the receiver device over an I2C or I3C bus.

7. The method of claim 1, wherein the payload included in the virtual general-purpose input/output and messaging interface packet is encrypted, and wherein an encryption marker bit in the virtual channel identifier is enabled to indicate that the payload is encrypted.

8. An apparatus, comprising:
a communication interface configured to communicate with one or more peripheral devices; and
a processing circuit coupled to the communication interface, the processing circuit configured to
obtain a payload to be transmitted to a receiver device;
obtain a virtual general-purpose input/output and messaging interface packet that includes at least the payload, a virtual channel identifier, and a function bit configured as a virtual channel marker bit to indicate that the virtual general-purpose input/output and messaging interface packet includes the virtual channel identifier, wherein the virtual channel identifier indicates information associated with processing the payload; and
transmit the virtual general-purpose input/output and messaging interface packet to the receiver device.

9. The apparatus of claim 8, wherein the processing circuit is further configured to:
set a virtual channel configuration register to indicate that the function bit is configured as the virtual channel marker bit; and
enable the function bit in the virtual general-purpose input/output and messaging interface packet.

10. The apparatus of claim 8, wherein the virtual channel identifier includes:
a virtual channel source device identifier that identifies the apparatus; and
a virtual channel function code that indicates the information associated with processing the payload.

11. The apparatus of claim 10, wherein the virtual channel function code includes at least a control channel marker bit, an encryption marker bit, a priority marker bit, or an acknowledge request marker bit.

12. The apparatus of claim 9, wherein the virtual channel identifier is included in a byte following the enabled function bit in the virtual general-purpose input/output and messaging interface packet.

13. The apparatus of claim 8, wherein the payload included in the virtual general-purpose input/output and messaging interface packet is encrypted, and wherein an encryption marker bit in the virtual channel identifier is enabled to indicate that the payload is encrypted.

14. An apparatus, comprising:
means for obtaining a payload to be transmitted to a receiver device;
means for obtaining a virtual general-purpose input/output and messaging interface packet that includes at least the payload, a virtual channel identifier, and a function bit configured as a virtual channel marker bit to indicate that the virtual general-purpose input/output and messaging interface packet includes the virtual channel identifier, wherein the virtual channel identifier indicates information associated with processing the payload; and
means for transmitting the virtual general-purpose input/output and messaging interface packet to the receiver device.

15. A processor-readable storage medium having one or more instructions which, when executed by at least one processor or state machine of a processing circuit, cause the processing circuit to:
obtain a payload to be transmitted to a receiver device;
obtain a virtual general-purpose input/output and messaging interface packet that includes at least the payload, a virtual channel identifier, and a function bit configured as a virtual channel marker bit to indicate that the virtual general-purpose input/output and messaging interface packet includes the virtual channel identifier, wherein the virtual channel identifier indicates information associated with processing the payload; and
transmit the virtual general-purpose input/output and messaging interface packet to the receiver device.

16. A method, comprising:
receiving, at a receiver device, a virtual general-purpose input/output and messaging interface packet from a transmitter device, wherein the virtual general-purpose input/output and messaging interface packet includes at least a payload and a virtual channel identifier;
determining, at the receiver device, that the virtual general-purpose input/output and messaging interface packet includes the virtual channel identifier based on a function bit configured as a virtual channel marker bit, wherein the virtual channel identifier indicates information associated with processing the payload; and
processing, at the receiver device, the payload based on the information.

17. The method of claim 16, wherein determining that the virtual general-purpose input/output and messaging interface packet includes the virtual channel identifier comprises:
determining that a virtual channel configuration register indicates that the function bit in the virtual general-purpose input/output and messaging interface packet is configured as the virtual channel marker bit; and
determining that the function bit in the virtual general-purpose input/output and messaging interface packet is enabled.

18. The method of claim 16, wherein the virtual channel identifier includes:
a virtual channel source device identifier that identifies the transmitter device; and
a virtual channel function code that indicates the information associated with processing the payload.

19. The method of claim 18, wherein the virtual channel function code includes at least a control channel marker bit, an encryption marker bit, a priority marker bit, or an acknowledge request marker bit.

20. The method of claim 17, wherein the virtual channel identifier is included in a byte following the enabled function bit in the virtual general-purpose input/output and messaging interface packet.

21. The method of claim 16, further comprising:
determining that an encryption marker bit in the virtual channel identifier is enabled, the enabled encryption marker bit indicating that the payload is encrypted,
wherein processing the payload comprises decrypting the payload.

22. An apparatus, comprising:
a communication interface configured to communicate with one or more peripheral devices; and
a processing circuit coupled to the communication interface, the processing circuit configured to
receive a virtual general-purpose input/output and messaging interface packet from a transmitter device, wherein the virtual general-purpose input/output and messaging interface packet includes at least a payload and a virtual channel identifier;
determine that the virtual general-purpose input/output and messaging interface packet includes the virtual channel identifier based on a function bit configured as a virtual channel marker bit, wherein the virtual channel identifier indicates information associated with processing the payload; and
process the payload based on the information.

23. The apparatus of claim 22, wherein the processing circuit configured to determine that the virtual general-purpose input/output and messaging interface packet includes the virtual channel identifier is further configured to:
determine that a virtual channel configuration register indicates that the function bit in the virtual general-purpose input/output and messaging interface packet is configured as the virtual channel marker bit; and
determine that the function bit in the virtual general-purpose input/output and messaging interface packet is enabled.

24. The apparatus of claim 22, wherein the virtual channel identifier includes:
a virtual channel source device identifier that identifies the transmitter device; and
a virtual channel function code that indicates the information associated with processing the payload.

25. The apparatus of claim 24, wherein the virtual channel function code includes at least a control channel marker bit, an encryption marker bit, a priority marker bit, or an acknowledge request marker bit.

26. The apparatus of claim 23, wherein the virtual channel identifier is included in a byte following the enabled function bit in the virtual general-purpose input/output and messaging interface packet.

27. The apparatus of claim 22, wherein the virtual general-purpose input/output and messaging interface packet is received over an I2C or I3C bus.

28. The apparatus of claim 22, wherein the processing circuit is further configured to:
determine that an encryption marker bit in the virtual channel identifier is enabled, the enabled encryption marker bit indicating that the payload is encrypted,
wherein processing the payload comprises decrypting the payload.

29. An apparatus, comprising:
means for receiving a virtual general-purpose input/output and messaging interface packet from a transmitter device, wherein the virtual general-purpose input/output and messaging interface packet includes at least a payload and a virtual channel identifier;
means for determining that the virtual general-purpose input/output and messaging interface packet includes the virtual channel identifier based on a function bit configured as a virtual channel marker bit, wherein the virtual channel identifier indicates information associated with processing the payload; and
means for processing the payload based on the information.

30. A processor-readable storage medium having one or more instructions which, when executed by at least one processor or state machine of a processing circuit, cause the processing circuit to:
receive a virtual general-purpose input/output and messaging interface packet from a transmitter device, wherein the virtual general-purpose input/output and messaging interface packet includes at least a payload and a virtual channel identifier;
determine that the virtual general-purpose input/output and messaging interface packet includes the virtual channel identifier based on a function bit configured as a virtual channel marker bit, wherein the virtual channel identifier indicates information associated with processing the payload; and
process the payload based on the information.
